(19) United States
(12) Patent Application Publication
(10) Pub. No.: US 2025/0126506 A1
(43) Pub. Date: Apr. 17, 2025

(54) SENSING OPERATION USING A DIFFERENTIAL MEASUREMENT BASED ON A DIFFERENT PROPAGATION PATHS

(71) Applicant: Lenovo (Singapore) Pte. Ltd., Singapore (SG)

(72) Inventors: Seyedomid Taghizadeh Motlagh, Oberursel (DE); Ali Ramadan Ali, Kraiburg am Inn (DE); Robin Rajan Thomas, Bad Nauheim (DE); Vijay Nangia, Woodridge, IL (US)

(21) Appl. No.: 18/912,485

(22) Filed: Oct. 10, 2024

Related U.S. Application Data
(60) Provisional application No. 63/589,582, filed on Oct. 11, 2023.

(51) Int. Cl. H04W 24/10; H04B 17/309

(52) U.S. Cl. CPC H04W 24/10; H04B 17/309

(57) ABSTRACT

Various aspects of the present disclosure relate to receiving a sensing configuration for sensing signal measurement and reporting, where the sensing configuration comprises an indication of a first propagation path and performing a first sensing measurement of the first propagation path in accordance with the sensing configuration. Aspects of the present disclosure may relate to performing a second sensing measurement of the second propagation path in accordance with the sensing configuration and transmitting a sensing measurement report comprising a differential sensing measurement based on the first sensing measurement and the second sensing measurement, where the differential sensing measurement indicates a difference in measured values associated with the first propagation path and the second propagation path.

### TECHNICAL FIELD

The present disclosure relates to wireless communications, and more specifically to techniques for performing a radio-based sensing operation using a differential measurement based on measurements made on different propagation paths.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). As used herein, a list with a conjunction of “and/or” includes any single item in the list or a combination of items in the list. For example, a list of A, B and/or C includes only A, or only B, or only C, or AB, or BC, or AC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include a means for receiving a sensing configuration for sensing signal measurement and reporting and performing a first sensing measurement of the first propagation path in accordance with the sensing configuration, where the sensing configuration includes an indication of a first propagation path and an indication of a second propagation path, the first propagation path being associated with a sensing target. The method and apparatuses described herein may include a means for performing a second sensing measurement of the second propagation path in accordance with the sensing configuration and transmitting a sensing measurement report comprising a differential sensing measurement based on the first sensing measurement and the second sensing measurement, where the differential sensing measurement indicates a difference in measured values associated with the first propagation path and the second propagation path.

In some implementations, the method and apparatuses described herein may further include a means for determining a set of radio nodes for performing a sensing procedure, the set of radio nodes comprising a set of receiving nodes. The method and apparatuses described herein may include a means for transmitting, to the set of receiving nodes, a sensing configuration for performing a sensing signal measurement and reporting, where the sensing configuration comprises an indication of a first propagation path and an indication of a second propagation path, and where the first propagation path is associated with a sensing target. The method and apparatuses described herein may include means for receiving a sensing measurement report comprising a differential sensing measurement and determining sensing information based at least in part on differential sensing measurement, where the differential sensing measurement indicates a difference in measured values associated with the first propagation path and the second propagation path.

### BRIEF DESCRIPTION OF THE DRAWINGS

FIG. 1 illustrates an example of a wireless communications system in accordance with aspects of the present disclosure.

FIG. 2 illustrates an example of a Third Generation Partnership Project (3GPP) New Radio (NR) protocol stack showing different protocol layers in the UE and network, in accordance with aspects of the present disclosure.

FIG. 3 illustrates an example of an instance of a radio sensing measurement procedure, in accordance with aspects of the present disclosure.

FIG. 4A illustrates an example of a first set of sensing scenarios for a radio sensing operation, in accordance with aspects of the present disclosure.

FIG. 4B illustrates an example of a second set of sensing scenarios for a radio sensing operation, in accordance with aspects of the present disclosure.

FIG. 5A illustrates an example of a tight coupling Information Sharing and Analysis Center (ISAC) network architecture, in accordance with aspects of the present disclosure.

FIG. 5B illustrates another example of a tight coupling ISAC network architecture, in accordance with aspects of the present disclosure.

FIG. 5C illustrates an example of an ISAC network architecture where the sensing function (SF) is co-located with the location management function (LMF), in accordance with aspects of the present disclosure.

FIG. 5D illustrates an example of a loose coupling ISAC network architecture, in accordance with aspects of the present disclosure.

FIG. 6 illustrates an example of a sensing scenario with differential measurement based mismatch compensation, in accordance with aspects of the present disclosure.

FIG. 7A illustrates an example of a first configuration for measuring a differential sensing measurement, in accordance with aspects of the present disclosure.

FIG. 7B illustrates an example of a second configuration for measuring a differential sensing measurement, in accordance with aspects of the present disclosure.

FIG. 7C illustrates an example of a third configuration for measuring a differential sensing measurement, in accordance with aspects of the present disclosure.

FIG. 7D illustrates an example of a fourth configuration for measuring a differential sensing measurement, in accordance with aspects of the present disclosure.

FIG. 7E illustrates an example of a fifth configuration for measuring a differential sensing measurement, in accordance with aspects of the present disclosure.

FIG. 7F illustrates an example of a sixth configuration for measuring a differential measurement, in accordance with aspects of the present disclosure.

FIG. 8 illustrates an example of a user equipment (UE) 800, in accordance with aspects of the present disclosure.

FIG. 9 illustrates an example of a processor 900, in accordance with aspects of the present disclosure.

FIG. 10 illustrates an example of a network equipment (NE) 1000, in accordance with aspects of the present disclosure.

FIG. 11 illustrates a flowchart of a method performed by a sensing measurement controller, in accordance with aspects of the present disclosure.

FIG. 12 illustrates a flowchart of a method performed by a participating radio node, in accordance with aspects of the present disclosure.

### DETAILED DESCRIPTION

Generally, the present disclosure describes systems, methods, and apparatuses for cell measurement and access to network energy saving cells. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

Radio-based environment sensing allows for improved the network performance of the cellular wireless networks, as well as enabling the cellular wireless networks to serve vertical use-cases, e.g., where sensing information is obtained (and exposed to the requesting entity) by the wireless communication network. As such, a radio sensing measurement procedure intends to generate and collect measurements to obtain sensing information of the target objects/environment and/or the involved radio nodes. Examples of the acquired sensing information (also referred to as “sensing results”) includes, but is not limited to, information of position, velocity, direction/heading, orientation, radar cross-section (RCS), shape, material/composition, etc., of a target object and/or of a participating radio node.

Such sensing information may be obtained by means of combination of the one or multiple of: i) transmission of a sensing signal, e.g., a sensing reference signal (RS), from a network or UE entity (hereafter referred to as a “sensing Tx node”); ii) reception of the reflections/echoes of the transmitted sensing excitation signal from the environment by a network or a UE entity (hereafter referred to as a “sensing Rx node”); and/or iii) processing of the received reflections and inferring relevant information from the environment.

Accordingly, the sensing measurement process may include: i) one or multiple (static or mobile) sensing Tx nodes with known sensing information or with (partially) unknown sensing information (e.g., known or unknown position); ii) one or multiple (static or mobile) sensing Rx nodes with known or (partially) unknown sensing information (e.g., known or unknown position); iii) one or multiple (static or mobile) objects/reflectors with known or (partially) unknown sensing information (e.g., known or unknown position, presence, RCS, etc.); or a combination thereof.

Aspects of the present disclosure are described in the context of a wireless communications system.

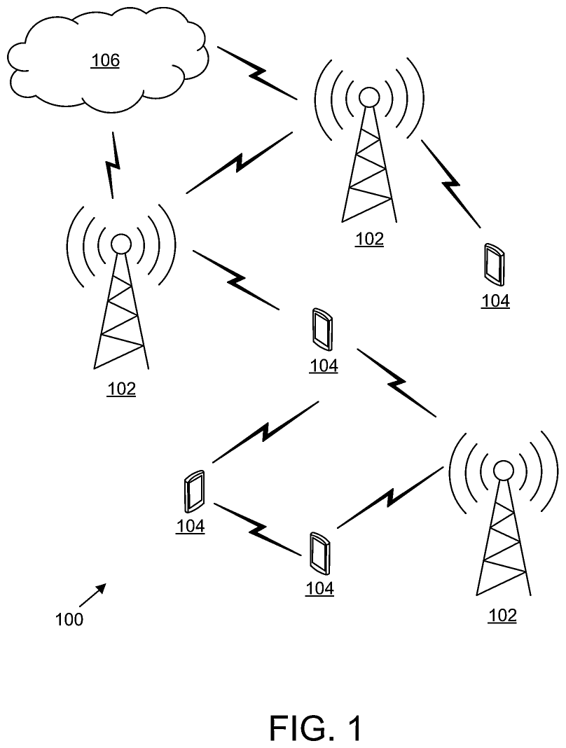

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4−1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

For initial access, a UE 104 detects a candidate cell and performs downlink (DL) synchronization. For example, the gNB (e.g., an embodiment of the NE 102) may transmit a synchronization signal and broadcast channel (SS/PBCH) transmission, referred to as a Synchronization Signal Block (SSB). The synchronization signal is a predefined data sequence known to the UE 104 (or derivable using information already stored at the UE 104) and is in a predefined location in time relative to frame/subframe boundaries, etc. The UE 104 searches for the SSB and uses the SSB to obtain DL timing information (e.g., symbol timing) for the DL synchronization. The UE 104 may also decode system information (SI) based on the SSB. Note that with beam-based communication, each DL beam may be associated with a respective SSB.

In 3GPP New Radio (NR), the gNB may transmit the maximum 64 SSBs and the maximum 64 corresponding copies of Physical Downlink Control Channel (PDCCH) and/or Physical Downlink Shared Channel (PDSCH) for delivery of System Information Block type 1 (SIB1) in high frequency bands (e.g., 28 GHz). As discussed in further detail below, the SSB (or another RS defined within the wireless communication system 100) may be utilized as a sensing RS signal and a UE 104 (and/or NE 102) may perform sensing measurements based on the SSB transmission. For example, a sensing radio node may detect a Line-of-Sight (LoS) condition based on the SSB transmission and a propagation path associated with the SSB transmission may then be used to perform differential measurement, in accordance with aspects of the present disclosure. As another example, the SSB may be utilized as a sensing RS signal over which a path associated with a sensing target can be detected.

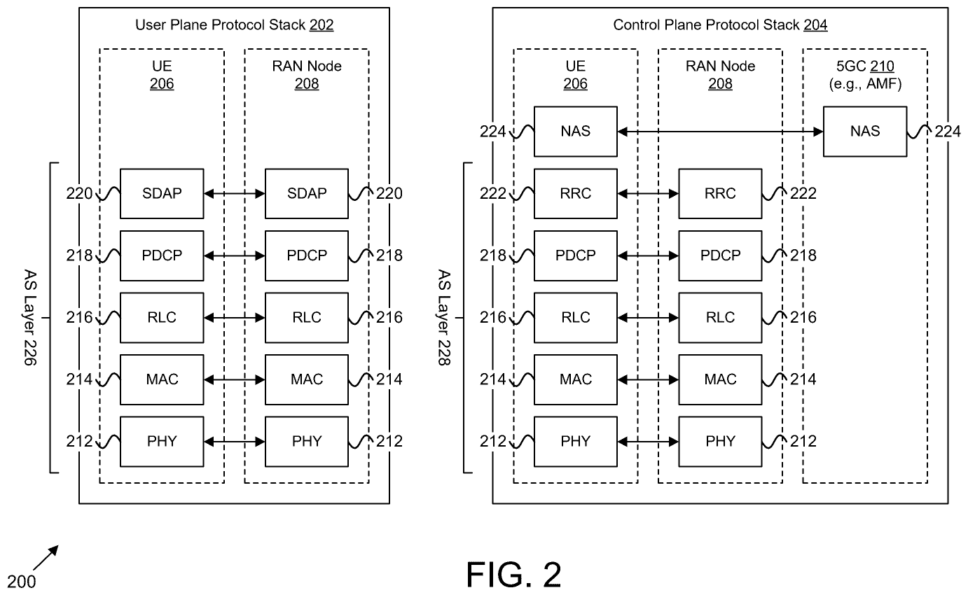

FIG. 2 illustrates an example of a NR protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the NR protocol stack 200 comprises a User Plane protocol stack 202 and a Control Plane protocol stack 204. The User Plane protocol stack 202 includes a physical (PHY) layer 212, a Medium Access Control (MAC) sublayer 214, a Radio Link Control (RLC) sublayer 216, a Packet Data Convergence Protocol (PDCP) sublayer 218, and a Service Data Adaptation Protocol (SDAP) sublayer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-1 (L1) includes the PHY layer 212. The Layer-2 (L2) is split into the SDAP sublayer 220, PDCP sublayer 218, RLC sublayer 216, and MAC sublayer 214. The Layer-3 (L3) includes the RRC layer 222 and the NAS layer 224 for the control plane and includes, e.g., an Internet Protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of Signaling Radio Bearers (SRBs) and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as Transport Blocks (TBs)) from MAC Service Data Units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as uplink (UL) or DL. Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

Note that an LTE protocol stack comprises similar structure to the NR protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP layer 240, RRC layer 222 and NAS layer 224) and a transmission layer in Multiple-Input Multiple-Output (MIMO) communication (also referred to as a “MIMO layer” or a “data stream”).

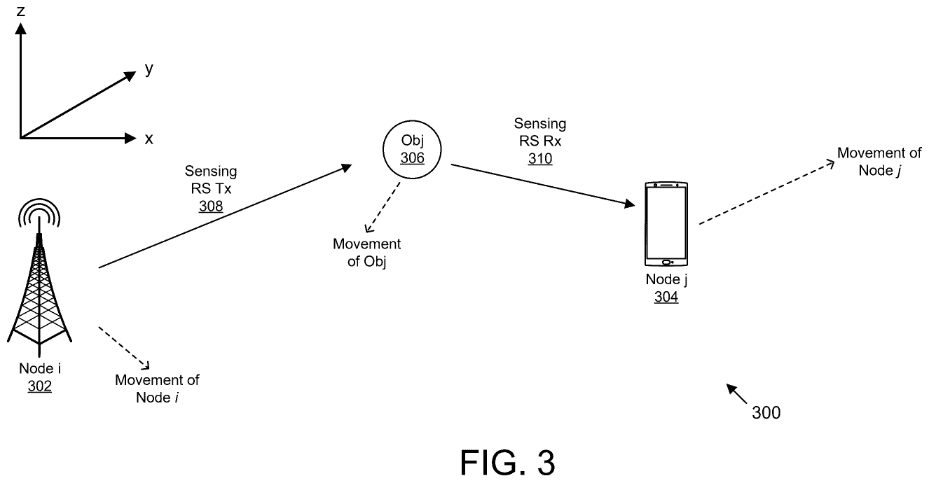

FIG. 3 illustrates an example of an instance 300 of a radio sensing measurement procedure, in accordance with aspects of the present disclosure. FIG. 3 illustrates a first sensing node (denoted “Node i”) 302 acting as a sensing transmitter (Tx) node in the instance 300, a second sensing node (denoted “Node j”) 304 acting as a sensing receiver (Rx) node in the instance 300, and a target object (denoted “Obj”) 306 whose sensing information is derived by the radio sensing measurement procedure. In the depicted instance 300, the Node i 302 performs the sensing RS transmission 308 and the Node j 304 performs the sensing RS reception 310. In some embodiments, the Node i 302 is static (i.e., not moving, having a fixed position). In other embodiments, the Node i 302 is mobile (i.e., moving). Similarly, in some embodiments, the Node j 304 is static (i.e., not moving, having a fixed position). In other embodiments, the Node j 304 is mobile (i.e., moving).

Each radio node that participates in the radio sensing measurement procedure has a position (p) and a velocity (v). In some embodiments, the position of a radio node is known to the network. In other embodiments, the position of the radio node is unknown. In some embodiments, the velocity of a radio node is known to the network. In other embodiments, the velocity of the radio node is unknown. Note that the participating radio node may be a UE, a gNB, or a transmit-receive point (TRP).

The Node i 302 and the Node j 304 are each elements of the set M, which is the set of transmission-reception (Tx-Rx) measurement pairs of radio nodes. Let [symbol] represent the set of reflectors and/or objects (reflectors/objects) and sensing Rx nodes with known or partially known sensing information. Let [symbol] represent the set of entities of interest with unknown or partially unknown sensing information and for which sensing information is to be estimated. Note that the set [symbol] may be a subset of the set [symbol] .

Note that the radio sensing measurement procedure is not restricted to the Tx-Rx scenarios with object/reflections, and may include the direct Tx/Rx Line-of-Sight (LoS) measurements, e.g., the LoS Time-of-Flight (ToF) or the LoS Angle-of-Arrival (AoA) estimation. For the instance 300 of the radio sensing measurement procedure, the following identities and timing, angular, doppler equalities are known to inform on the sensing information of the object and/or the radio nodes: True ToF value, Estimated ToF value, True doppler shift value, Estimated doppler shift value, True AoA and Zenith-of-Arrival (ZoA) values, Estimated AoA and ZoA values.

The true ToF value, according to the defined scenario parameters, is expressed as:

$$ToF ( {p}_{obj} , {p}_{i} , {p}_{j} ) = {‖ {p}_{obj} - {p}_{i} ‖}_{2} / c + {‖ {p}_{obj} - {p}_{j} ‖}_{2} / c \qquad Eq . 1$$

where p_{obj} is the position of the target object 306, pᵢ is the position of the Node i 302, pⱼ is the position of the Node j 304, and c is the speed of light.

The estimated ToF at the receiver (i.e., Node j 304) at the time instance t, including impact of the time synchronization mismatch (assumed to be constant during the measurement period) between the Tx-Rx node pairs denoted by Δ_{T,ij} as well as the impact of the additive noise on the measurement (e.g., including impact of non-constant clock offset), denoted by n_{T,j(t)}, is expressed as:

$$T \tilde{o} {F}_{j} ( {p}_{obj} , {p}_{i} , t ) = {‖ {p}_{obj} - {p}_{i} ‖}_{2} / c + {‖ {p}_{obj} - {p}_{j} ‖}_{2} / c + {Δ}_{T , ij} + {n}_{T , j} ( t ) \\ ( i , j ) ∈ ℳ , obj ∈ 𝒪 \qquad Eq . 2$$

The true doppler shift value, according to the defined scenario parameters, is expressed as:

$${f}_{D} ( {p}_{obj} , {v}_{obj} , {p}_{i} , {v}_{i} , {p}_{j} , {v}_{j} ) = {( {v}_{i} - {v}_{obj} )}^{T} \frac{{p}_{obj} - {p}_{i}}{λ {‖ {p}_{obj} - {p}_{i} ‖}_{2}} + {( {v}_{j} - {v}_{obj} )}^{T} \frac{{p}_{obj} - {p}_{j}}{λ {‖ {p}_{obj} - {p}_{j} ‖}_{2}} \qquad Eq . 3$$

where the notation (·)^{T} denotes the transpose, where v_{obj} is the velocity of the target object 306, vᵢ is the velocity of the Node i 302, vⱼ is the velocity of the Node j 304, and λ is the wavelength of the transmitted sensing signal.

The estimated doppler shift value at the receiver (i.e., Node j 304), including impact of the constant (during the measurement period) frequency synchronization mismatch/offset between the Tx-Rx node pairs, denoted as Δ_{F,ij}, as well as the impact of additive noise (including non-constant frequency offset) on the measurement, is expressed as:

$${\tilde{f}}_{D , j} ( {p}_{obj} , {v}_{obj} , {p}_{i} , {v}_{i} , t ) = {( {v}_{i} - {v}_{obj} )}^{T} \frac{{p}_{obj} - {p}_{i}}{λ {‖ {p}_{obj} - {p}_{i} ‖}_{2}} + {( {v}_{j} - {v}_{obj} )}^{T} \frac{{p}_{obj} - {p}_{j}}{λ {‖ {p}_{obj} - {p}_{j} ‖}_{2}} + {Δ}_{F , ij} + {n}_{D , j} ( t ) \qquad Eq . 4$$

The true AoA and ZoA values, wherein ∠_{Z}, ∠_{A} compute the zenith and azimuth angle of a vector presented in the cartesian space, respectively, are expressed as:

$${A}_{Z} ( {p}_{obj} , {p}_{i} , {p}_{j} ) = {∠}_{Z} ( {p}_{j} - {p}_{obj} ) \\ {A}_{A} ( {p}_{obj} , {p}_{i} , {p}_{j} ) = {∠}_{A} ( {p}_{j} - {p}_{obj} ) \qquad Eq . 5$$

The estimated AoA and ZoA values at the receiver (i.e., Node j 304), including impact of constant (during the measurement period) coordinate system mismatch (angular synchronization) in the azimuth and zenith directions (denoted as Δ_{Z,j}, Δ_{A,j}) and impact of additive noise on the measurement process, are expressed as:

$${\overline{A}}_{A , j} ( {p}_{obj} , {p}_{i} , t ) = {∠}_{A} ( {p}_{obj} , {p}_{i} ) + {Δ}_{A , j} + {n}_{A , j} ( t ) \\ {\overline{A}}_{Z , j} ( {p}_{obj} , {p}_{i} , t ) = {∠}_{Z} ( {p}_{obj} - {p}_{i} ) + {Δ}_{Z , j} + {o}_{Z , j} ( t ) \qquad Eq . 6$$

Upon acquisition of the above-defined measurement estimates as expressed in Equation 2, Equation 4, and Equation 6, and utilizing the knowledge of the structures as expressed in Equation 1, Equation 3, and Equation 5, the estimation of the object and/or radio Tx-Rx node positioning/sensing information can be then obtained, e.g., following a loss-minimization approach, wherein a loss function represents a measure of observable error (of the positioning variables of interest) from the collected measurements.

In some embodiments, the least square example loss-function can be hence utilized as:

$$L ( \{ {p}_{obj} , {v}_{obj} \} , \{ {p}_{i} , {v}_{i} , {p}_{j} , {v}_{j} \} ) = {\sum }_{l ∈ 𝒯} {\sum }_{obj ∈ 𝒪} {\sum }_{( i , j ) ∈ ℳ} 𝔼 \{ {W}_{⊤} {‖ T o {F}_{j} ( {p}_{obj} , {p}_{i} , t ) - T \tilde{o} F ( {p}_{obj} , {p}_{i} , {p}_{j} ) ‖}_{2}^{2} + {W}_{D} {‖ {\tilde{f}}_{D , j} ( {p}_{obj} , {v}_{obj} , {p}_{i} , {v}_{i} , t ) - {f}_{D} ( {p}_{obj} , {v}_{obj} , {p}_{i} , {v}_{i} , {p}_{j} , {v}_{j} ) ‖}_{2}^{2} + {W}_{A} {‖ {\tilde{A}}_{A , j} ( {p}_{obj} , {p}_{i} , t ) - {A}_{A} ( {p}_{obj} , {p}_{i} , {p}_{j} ) ‖}_{2}^{2} + {W}_{Z} {‖ {\tilde{A}}_{Z , j} ( {p}_{obj} , {p}_{i} , t ) - {A}_{Z} ( {p}_{obj} , {p}_{i} , {p}_{j} ) ‖}_{2}^{2} \} \qquad Eq . 7$$

wherein the positive-real valued weights W_{T}, W_{D}, W_{A}, W_{Z} represent significance of different measurement parts, associated with the ToF estimates, doppler estimates, and azimuth and elevation angular estimates, respectively.

The estimate of the position and velocity of the object and/or radio nodes, described as obj∈ [symbol] ₓ, is hence obtained as a minimizer of the constructed Loss function, and expressed as:

$${\{ \tilde{{p}_{obj}} , \tilde{{v}_{obj}} \}}_{obj ∈ {𝒪}_{X}} = {arg min}_{{\{ {p}_{obj} , {v}_{obj} \}}_{obj ∈}} \{ L ( \{ {p}_{obj} , {v}_{obj} \} , \{ {p}_{i} , {v}_{i} , {p}_{j} , {v}_{j} \} ) \} \qquad Eq . 8$$

Please note that the above identities and parameter estimates are not intended to be limited to a transmission-reflection-reception setup, and the related LoS measurements of a Tx-Rx path (e.g., LoS ToF, AoA, doppler shift etc.) can be obtained by setting the object as the receiver node (i.e., obj=j∈ [symbol] ) and eliminating the parts of the expression including P_{obj}−Pⱼ and v_{obj}−vⱼ, i.e., eliminating the terms expressing the impact of object-Rx propagation.

The following observations follow from the expressions of Equations 1-8 relating the estimates of a desired sensing information (e.g., a radio node or object's position or velocity information) to the inherent inaccuracies of the measurement process, more prominently, the unknown but constant (during the measurement process) offset of time, frequency and angular reference of a Tx-Rx node, and the dynamic additive noise.

Observation 1: The loss function is lower bounded as following, wherein the bound is achieved upon infinitely accurate estimation of the unknown sensing variables

$${\{ , \}}_{obj ∈ 𝒪} \\ L ( \{ {p}_{obj} , {v}_{obj} \} , \{ {p}_{i} , {v}_{i} , {p}_{j} , {v}_{j} \} ) \geq {\sum }_{i ∈ 𝒯} {\sum }_{obj ∈ 𝒪} {\sum }_{( i , j ) ∈ ℳ} \{ {W}_{⊤} {‖ {Δ}_{T , ij} + {n}_{T , j} ( t ) ‖}_{2}^{2} + {W}_{D} {‖ {Δ}_{D , ij} + {n}_{D , j} ( t ) ‖}_{2}^{2} + {W}_{A} {‖ {Δ}_{A , ij} + {n}_{A , j} ( t ) ‖}_{2}^{2} + {W}_{Z} {‖ {Δ}_{Z , ij} + {n}_{Z , j} ( t ) ‖}_{2}^{2} \} \qquad Eq . 9$$

Observation 2: The inflicted measurement errors (including constant and variable offsets) are (almost) independent from the known and unknown sensing information of the objects and/or the radio nodes (e.g., the frequency offset of a sensing Rx node is statistically independent from the node position), and hence cannot be inferred/obtained (and hence removed) based on the available problem data (e.g., known node position, velocity, etc.).

Observation 3: It is observed that the UE basic measurement interval of modulated carrier frequency is 1 UL slot. 3GPP specifications state that the mean value of basic measurements of UE modulated carrier frequency shall be accurate to within ±0.1 parts per million (PPM) observed over a period of 1 ms of cumulated measurement intervals compared to the carrier frequency received from the gNB. The stated carrier frequency offset of +/−0.1 PPM contributes significantly to the established error lower bound in Equation 9 and may lead to a mismatch of +/−30 m/see of velocity estimate for a single measurement point, assuming a direction of movement along the object-sensing Rx node or along the object-sensing Tx node.

Observation 4: The time and angular synchronization quality of a UE with a reference device may be limited depending on the device type and/or the usage scenario, e.g., an out-of-coverage UE with no accurate synchronization reference and a UE with dynamic position and orientation (due to the hand/head movement). The inaccuracies further contribute to the error terms of Equation 9 and lead to impaired quality of the sensing measurements.

In view of the above observations, and further in view of the required sensing key performance indicators (KPI), e.g., the use case KPIs with sub-meter and/or sub-meter/sec position, and velocity estimate accuracy requirements, the present disclosure describes techniques whereby the correlation among the erroneous parts of the estimation error lower bound as established in Equation 9, among multiple sensing measurements of different paths, different nodes and at different time instances etc., is utilized to reduce/compensate the error of the sensing measurements, wherein the sensing measurements are performed in the context of a wireless cellular networks and for the purpose of obtaining a desired sensing information of a target object and/or of radio node.

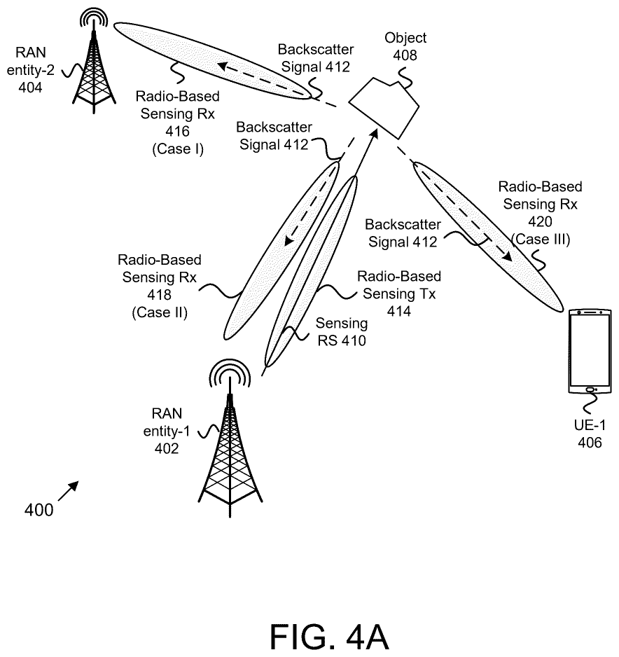

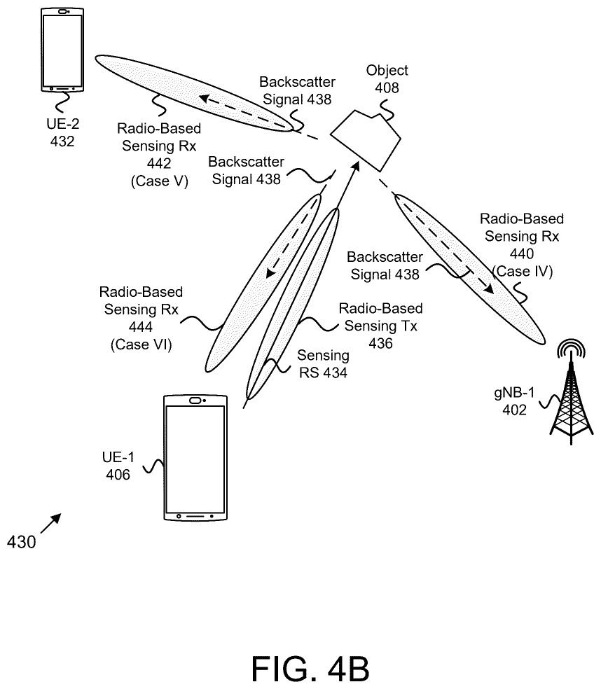

Regarding network-based and UE-based (i.e., SL-based) radio sensing operations, different scenarios for radio sensing are presented in FIGS. 4A and 4B. In some scenarios of radio sensing, the network configures the participating sensing entities, i.e., network and UE nodes acting as sensing Tx nodes, network and UE nodes acting as sensing Rx nodes, as well as the configuration of sensing RS and necessary measurements and reporting procedures from the nodes. In this regard, the functional split between the network and the UE nodes for a specific sensing task may take various forms, depending on the availability of sensing-capable devices and the requirements of the specific sensing operation.

FIG. 4A depicts possibilities for sensing scenarios for a radio sensing operation 400 where a RAN entity performs a sensing RS transmission, according to embodiments of the disclosure. In the scenarios of FIG. 4A, sensing RS reception is performed by one or more UEs, one or more RAN entities, or a combination thereof. The radio sensing operation 400 may involve a first RAN entity 402 (e.g., a gNB or network TRP node), a second RAN entity 404 (e.g., a gNB or a network TRP node), and/or a set of at least one UE (represented by the first UE 406).

In various embodiments, the radio sensing operation 400 is used to detect and locate an object of interest 408. In general, a Radio-based sensing transmission 410 is performed by the first RAN entity 402. While the below examples describe the Radio-based sensing transmission 410 using a sensing reference signal (“sensing RS”) 412, in other embodiments the Radio-based sensing transmission 410 may be a transmission of another RS or instead may be a transmission of the data/control channels known to the network TRP nodes.

In a first sensing scenario (also referred to herein as “Case I”), the Radio-based sensing transmission 410 is performed by a first network node (i.e., the first RAN entity 402) and the Radio-based sensing reception 416 is performed by a separate network node (i.e., the second RAN entity 404). In this case, the sensing RS 412 (or another RS used for sensing) is transmitted and a reflection/backscatter signal 414 is received by network entities. The network does not utilize UEs for sensing assistance in this scenario. Rather, the involvement of UE nodes (i.e., first UE 406) is limited to the aspects of interference management, when necessary.

In a second sensing scenario (also referred to herein as “Case II”), the Radio-based sensing transmission 410 is performed by a first network node (i.e., the first RAN entity 402) and the Radio-based sensing reception 418 is performed by the same network node. In this case, the sensing RS 412 (or another RS used for sensing) is transmitted and a reflection/backscatter signal 414 is received by the same network entity. The network does not utilize UEs for sensing assistance in this scenario. Rather, the involvement of UE nodes (i.e., first UE 406) is limited to the aspects of interference management, when necessary.

In a third sensing scenario (also referred to herein as “Case III”), the Radio-based sensing transmission 410 is performed by a first network node (i.e., the first RAN entity 402) and the Radio-based sensing reception 420 is performed by a UE node (i.e., the first UE 406). In this case, the sensing RS 412 (or other RS used for sensing) is transmitted by a network entity and a reflection/backscatter signal 414 is received by one or multiple UE nodes, including the first UE 406. The network configures the UEs to act as a sensing Rx node, according to the UE capabilities for sensing, as well as desired sensing task.

FIG. 4B depicts possibilities for sensing scenarios for a radio sensing operation 430 where a UE performs a sensing RS transmission, according to embodiments of the disclosure. In the scenarios of FIG. 4B, sensing RS reception is performed by one or more UEs, one or more RAN entities, or a combination thereof. The radio sensing operation 430 may involve the first UE 406, a set of at least one peer UE (represented by the second UE 432), and/or a set of at least one TRP (represented by the first RAN entity 402).

In various embodiments, the radio sensing operation 430 is used to detect and locate an object of interest 408. In general, a Radio-based sensing transmission 434 is performed by the first UE 406. While the below examples describe the Radio-based sensing transmission 434 using a sensing RS 436, in other embodiments the Radio-based sensing transmission 434 may be a transmission of another RS or instead may be a transmission of the data/control channels.

In a fourth sensing scenario (also referred to herein as “Case IV”), the Radio-based sensing transmission 434 is performed by a first UE 406 and the Radio-based sensing reception 440 is performed by a RAN entity (i.e., the first RAN entity 402). In this case, the sensing RS 436 (or another RS transmitted for sensing) is transmitted by a UE node and a reflection/backscatter signal 438 is received by one or multiple network entities. The network configures the transmitting UE (i.e., the first UE 406) to act as a sensing Tx node, according to the UE nodes' capabilities for sensing, as well as the nature of the desired sensing task.

In a fifth sensing scenario (also referred to herein as “Case V”), the Radio-based sensing transmission 434 is performed by a first UE 406 and the Radio-based sensing reception 442 is performed by a separate UE (i.e., the second UE 432). In this case, the sensing RS 436 (or another RS transmitted for sensing) is transmitted by a UE node and a reflection/backscatter signal 438 is received by one or multiple UE nodes. The network, or potentially the first UE 406, may decide on configuration of the sensing scenario. In one instance, the network configures the UEs to act as a sensing Tx node and/or sensing Rx nodes, according to the UE nodes capabilities for sensing, as well as the nature of the desired sensing task.

In a sixth sensing scenario (also referred to herein as “Case VI”), the Radio-based sensing transmission 434 is performed by a first UE 406 and the Radio-based sensing reception 444 is performed by the same UE. In this case, the sensing RS 436 (or another RS transmitted for sensing) is transmitted by a UE node and a reflection/backscatter signal 438 is received by the same UE node. The UE or the network configures the sensing scenario, according to the UE nodes capabilities for sensing, as well as the nature of the desired sensing task.

The above radio sensing scenarios are described in further detail in U.S. application Ser. No. 17/538,978 entitled “CONFIGURING A SENSING REFERENCE SIGNAL” and filed on Nov. 30, 2021 for Seyedomid Taghizadeh Motlagh, Ali Ramadan Ali, Ankit Bhamri, Sher Ali Cheema, Razvan-Andrei Stoica, Hyejung Jung and Vijay Nangia, and also described in further detail in U.S. application Ser. No. 17/538,998 entitled “SENSING REFERENCE SIGNAL CONFIGURATION” and filed on Nov. 30, 2021 for Seyedomid Taghizadeh Motlagh, Ali Ramadan Ali, Ankit Bhamri, Sher Ali Cheema, Razvan-Andrei Stoica, Hyejung Jung and Vijay Nangia, which applications are incorporated herein by reference.

Moreover, the above scenarios are not intended to be restricted to a specific UE type, and may include any UE category. In any of the above scenarios, and of the roles elaborated for gNB and/or UE may be replaced (with equal validity for any example of a radio sensing scenario) with any UE or RAN node, e.g., a smart repeater node, an Integrated Access and Backhaul (IAB) node, a road side unit (RSU), etc. In some examples, the set of sensing Tx nodes of a sensing measurement process (and similarly, but may be independently, a sensing Rx nodes of a sensing measurement process) include one or more of a TRP associated with a gNB-CU/DU, a gNB distributed unit (gNB-DU), a gNB control unit (gNB-CU), a UE, a network controlled repeater (NCR), an IAB node, an RSU, or a dedicated sensing radio. In some embodiments, a sensing Rx node may as well be a non-3GPP sensor with capability of providing non-3GPP sensing data, or a 3GPP node (e.g., a UE or a RAN node) connected to the non-3GPP sensor and can obtain, process, and transfer the non-3GPP sensing data of the non-3GPP sensor to other 3GPP nodes/entities.

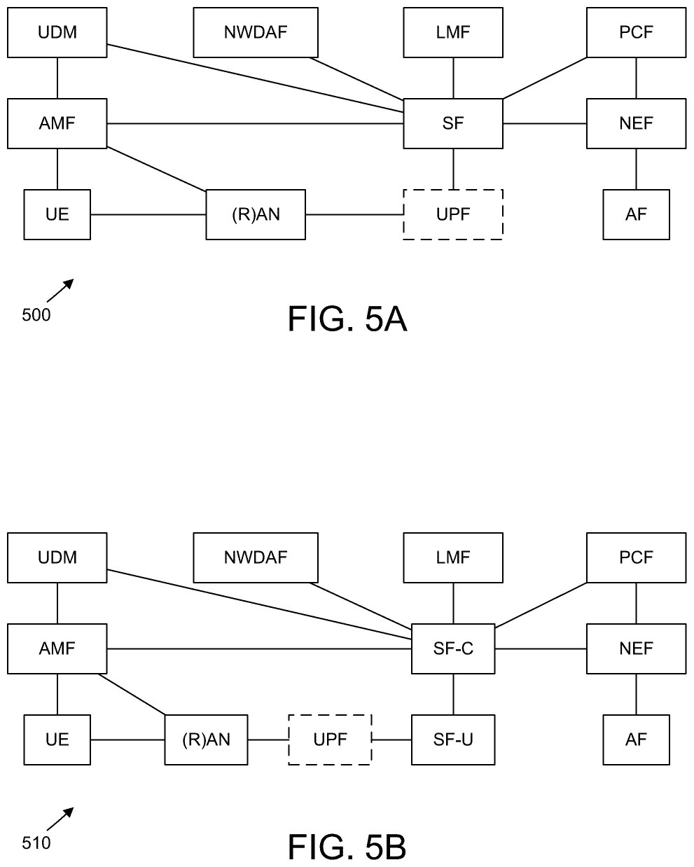

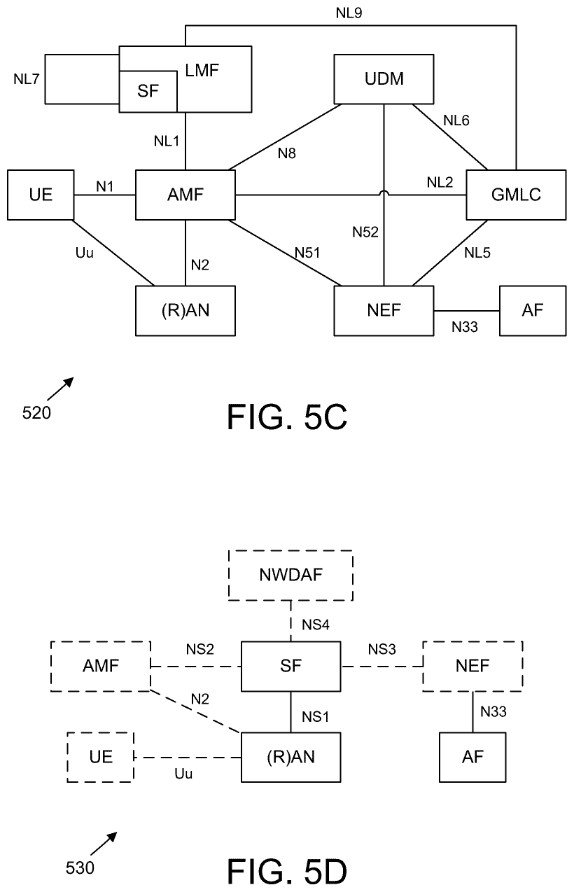

Integrated sensing and communication may enhance 5G core architecture by introducing a new Sensing Function (SF). FIGS. 5A-5D present possible combinations leading to the network impact.

FIG. 5A illustrates an example of a tight coupling Information Sharing and Analysis Center (ISAC) network architecture 500 with a unified SF (i.e., where the SF is not split between the control plane (CP) and user plane (UP) domains. As depicted, the SF is communicatively coupled to the Access and Mobility management Function (AMF), the Unified Data Management node (UDM), the Network Data Analytics Function (NWDAF), the Location Management Function (LMF), the Policy Control Function (PCF), the Network Exposure Function (NEF), and to the (radio) access network ((R)AN), optionally via the User Plane Function (UPF).

In the tight coupling ISAC network architecture of FIG. 5A, the SF appears as a dedicated network function (NF) handling both: (i) the sensing control plane aspects such as the interaction with the sensing consumer via NEF and information exchange with other NFs, for gathering UE information, (i.e., from the AMF, the UDM, the LMF), for gathering UE related policies from the PCF, and for gathering analytics from the NWDAF; and (ii) the sensing radio signals for performing the analysis or prediction for determining the sensing target.

FIG. 5B illustrates another example of a tight coupling ISAC network architecture 510, where the SF is functionally split/distributed among the CP and UP domains. As depicted, a CP split of the SF (SF-C) is communicatively coupled to the AMF, the UDM, the NWDAF, the LMF, the PCF, and the NEF. Additionally, a UP split of the SF (SF-C) is communicatively coupled to the (R)AN, optionally via the UPF.

In the tight coupling ISAC network architecture 510 with CP/UP split, the SF has two dedicated NF counter parts: (i) SF-C that handles the control plane aspects as described above and (ii) SF-U that is responsible for collecting the sensing radio signals via the user plane, i.e., via the (R)AN and the UPF. The idea of this architecture is to split and offload heavy data volumes associated with sensing radio signals to the user plane to ensure light traffic, i.e., only signaling, in the control plane.

FIG. 5C illustrates an example of an ISAC network architecture 520, where the SF is co-located with the LMF. The SF is communicatively coupled with the LMF, where the co-located nodes are also coupled with the Gateway Mobile Location Center (GMLC) and the AMF. As depicted, the GMLC is additionally coupled with the UDM, the AMF and the NEF. The AMF is additionally coupled with the UDM, the NEF, the (R)AN, and the UE. The NEF is additionally coupled with the application function (AF). The (R)AN is additionally coupled with the UE. The inter-function interfaces (i.e., reference points) are labeled in FIG. 5C. In the example of FIG. 5C, the SF (i.e., co-located with the LMF) appears as a logical NF embedded in the LMF to perform sensing taking advantage of the knowledge of a UE location.

FIG. 5D illustrates an example of a loose coupling ISAC network architecture 530, where the SF is communicatively coupled with the (R)AN and with the AF, optionally via the NEF. The SF may optionally be coupled with one or more of: the AMF (directly or via the (R)AN), the NWDAF, the NEF, and the UE (via the (R)AN). The inter-function interfaces (i.e., reference points) are labeled in FIG. 5C.

In the loose coupling ISAC network architecture 530, the SF is independent of the 5G core, i.e., typically used for local field scenarios or private networks, and the interaction with the 5G core is minimal. The main idea is to use SF close to the RAN, i.e., collect and process the sensing radio signals locally, and interact with 5G core for the purpose of exposure via NEF, for getting the UE location from the AMF and for analytics (i.e., NWDAF interaction).

In another description of controlling a sensing operation, in some example implementations, a sensing controller entity/function (SensMF) is defined which comprises one or multiple of a UE, a RAN node, a gNB/gNB-CU, an LMF, an SF, or a combination thereof, wherein the SensMF performs one or multiple of: A) Receives request for sensing information from a service consumer (e.g., a requesting third party application); B) Determines selection and/or configuration of a sensing operation, including configuration of one or more of a sensing Tx node, sensing Rx node; C) Selects and/or configures the involved nodes for sensing transmission and sensing reception and sensing measurement and reporting of the conducted measurements; D) Collects the sensing measurements; E) Performs or configures or requests computation of the sensing measurements and thereby determines the required sensing information based on the obtained sensing measurements; and/or F) Reports/exposes an obtained sensing information to the entity requesting the sensing information.

In some examples wherein the SensMF is comprised of multiple nodes/entities, one part of the above-mentioned steps may be implemented by the first part of the SensMF and the second part of the above steps may be implemented by the second part of the SensMF, e.g., implemented in the SF and gNB. In some examples wherein the SensMF is comprised of multiple nodes/entities, the communication among the SensMF entities are transparent to the outside entities and also not discussed in the related handover procedure embodiments, nevertheless, the communication among the SensMF entities are assumed to be implicit to the overall procedure.

In some examples, wherein a SensMF is comprised of an SF and a gNB (e.g., serving/head gNB of a related UE to the sensing task or a selected serving gNB for a sensing task), the SF performs the steps A, F, E, D whereas the steps B, C are performed by the selected gNB node. In some other examples, the step B, D are jointly performed by the SF and the selected gNB, wherein a first part of the configuration/configuration determination are performed by the SF and a second part of the configuration/configuration determination is performed by the selected gNB. The SensMF may be a RAN node (e.g., a selected gNB node acting as serving gNB of a sensing task), may be a sensing function (SF) residing in core network, may be a UE, or a combination thereof.

The following L1 measurements are relevant to sensing operation in accordance with the present disclosure: UE Rx-TX time difference; gNB Rx-Tx time difference, DL positioning reference signal (PRS) reference signal received path power (RSRPP), UL sounding reference signal (SRS) RSRPP.

The UE Rx-Tx time difference is defined as T_{UE-RX}−T_{UE-TX}, where T_{UE-RX} is the UE received timing of downlink subframe #i from a Transmission Point (TP), defined by the first detected path in time, and where T_{UE-TX} is the UE transmit timing of uplink subframe #j that is closest in time to the subframe #i received from the TP. Note that multiple DL PRS or channel state information reference signals (CSI-RS) for tracking resources, as instructed by higher layers, can be used to determine the start of one subframe of the first arrival path of the TP.

For frequency range #1 (FR1), the reference point for T_{UE-RX} measurement is the Rx antenna connector of the UE and the reference point for T_{UE-TX} measurement is the Tx antenna connector of the UE. For frequency range #2 (FR2), the reference point for T_{UE-RX} measurement is the Rx antenna of the UE and the reference point for T_{UE-TX} measurement is the Tx antenna of the UE. The UE Rx-Tx time difference is applicable to a UE in the RRC_CONNECTED state and in the RRC_INACTIVE state.

The gNB Rx-Tx time difference is defined as T_{gNB-RX}−T_{gNB-TX}, where T_{gNB-RX} is the Transmission and Reception Point (TRP) received timing of uplink subframe #i containing SRS associated with UE, defined by the first detected path in time, and where T_{gNB-TX} is the TRP transmit timing of downlink subframe #j that is closest in time to the subframe #i received from the UE. Multiple SRS resources can be used to determine the start of one subframe containing SRS.

The reference point for the T_{gNB-RX} shall be: the Rx antenna connector for a type 1-C base station (e.g., as described in 3GPP Technical Specification (TS) 38.104); the Rx antenna (i.e., the center location of the radiating region of the Rx antenna) for a type 1-O or 2-O base station (e.g., as described in 3GPP TS 38.104), or the Rx Transceiver Array Boundary connector for a type 1-H base station (e.g., as described in 3GPP TS 38.104).

Similarly, the reference point for the T_{gNB-TX} shall be: the Tx antenna connector for a type 1-C base station (e.g., as described in 3GPP TS 38.104); the Tx antenna (i.e., the center location of the radiating region of the Tx antenna) for a type 1-O or 2-O base station (e.g., as described in 3GPP TS 38.104), or the Tx Transceiver Array Boundary connector for a type 1-H base station (e.g., as described in 3GPP TS 38.104).

The DL PRS-RSRPP is defined as the power of the linear average of the channel response at the i-th path delay of the resource elements that carry DL PRS signal configured for the measurement, where DL PRS-RSRPP for the 1st path delay is the power contribution corresponding to the first detected path in time.

For FR1, the reference point for the DL PRS-RSRPP shall be the antenna connector of the UE. For FR2, DL PRS-RSRPP shall be measured based on the combined signal from antenna elements corresponding to a given receiver branch. The UE Rx-Tx time difference is applicable to a UE in the RRC_CONNECTED state and in the RRC_INACTIVE state.

The UL SRS-RSRPP is defined as the power of the linear average of the channel response at the i-th path delay of the resource elements that carry the received UL SRS signal configured for the measurement, where UL SRS-RSRPP for 1st path delay is the power contribution corresponding to the first detected path in time.

The reference point for UL SRS-RSRPP shall be: the Rx antenna connector for a type 1-C base station (e.g., as described in 3GPP TS 38.104); based on the combined signal from antenna elements corresponding to a given receiver branch for a type 1-0 or 2-0 base station (e.g., as described in 3GPP TS 38.104), or the Rx Transceiver Array Boundary connector for a type 1-H base station (e.g., as described in 3GPP TS 38.104).

For FR1 and FR2, if receiver diversity is in use by the gNB for UL SRS-RSRPP measurements, then: 1) The reported UL SRS-RSRPP value for the first and additional paths shall be provided for the same receiver branch(es) as applied for UL SRS-RSRP measurements, or 2) The reported UL SRS-RSRPP value for the first path shall not be lower than the corresponding UL SRS-RSRPP for the first path of any of the individual receiver branches and the reported UL SRS-RSRPP for the additional paths shall be provided for the same receiver branch(es) as applied UL SRS-RSRPP for the first path.

Let X_{j,1} and X_{j,2} be two sensing measurements of the same type (e.g., a path Time-of-Arrival (ToA), AoA ZoA, doppler shift etc.) at the sensing Rx node j, and wherein the measurements are impacted with an additive synchronization mismatch of one or more of time, frequency, angle. Then, for the measurement difference of X_{j,1}−X_{j,2}, it is observed that the impact of a fixed additive error (clock mismatch, carrier frequency offset (CFO), Local Coordinate System mismatch caused by rotation of unitary basis vectors) is eliminated.

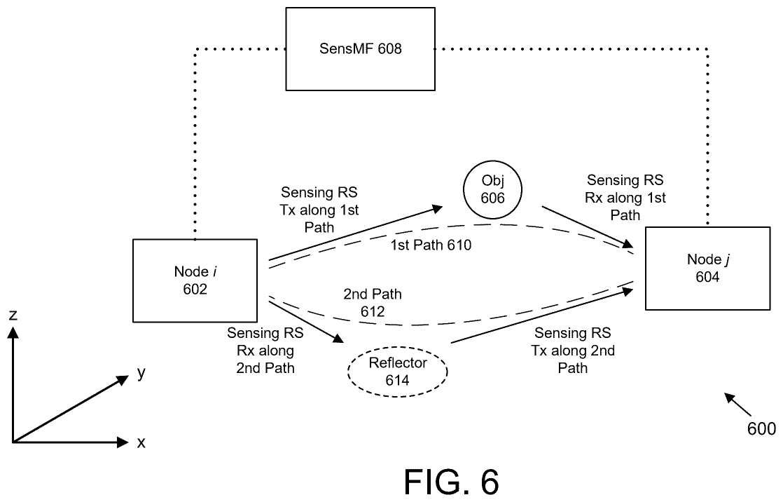

FIG. 6 illustrates an exemplary sensing scenario 600 of differential measurement based mismatch compensation, in accordance with aspects of the present disclosure. The sensing scenario 600 involves a sensing Tx node (denoted “Node i”) 602 and a sensing Rx node (denoted “Node j”) 604, configured to perform a sensing task to determine sensing information (e.g., position, velocity, material/composition, etc.) of a target object 606. The Node i 602 and Node j 604 may be configured by a SensMF 608, which may be a UE, a RAN node, a gNB/gNB-CU, an LMF, an SF, or a combination thereof. Note that in certain circumstances, the SensMF 608 may be either the Node i 602 of the Node j 604.

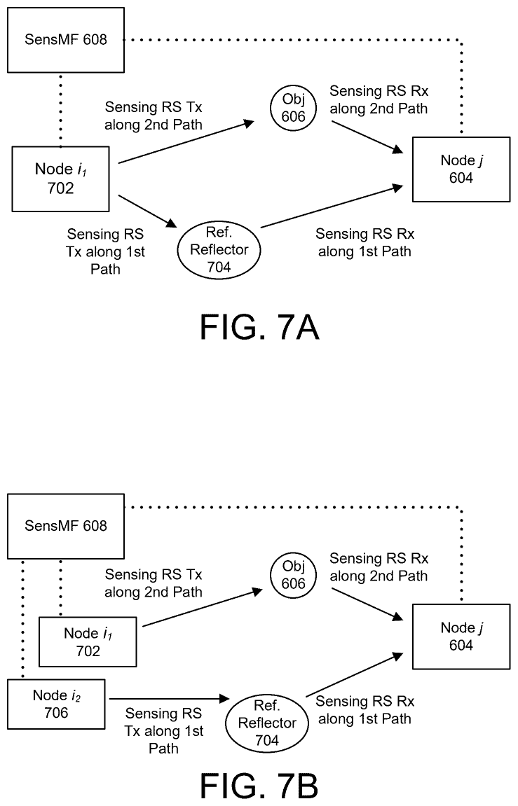

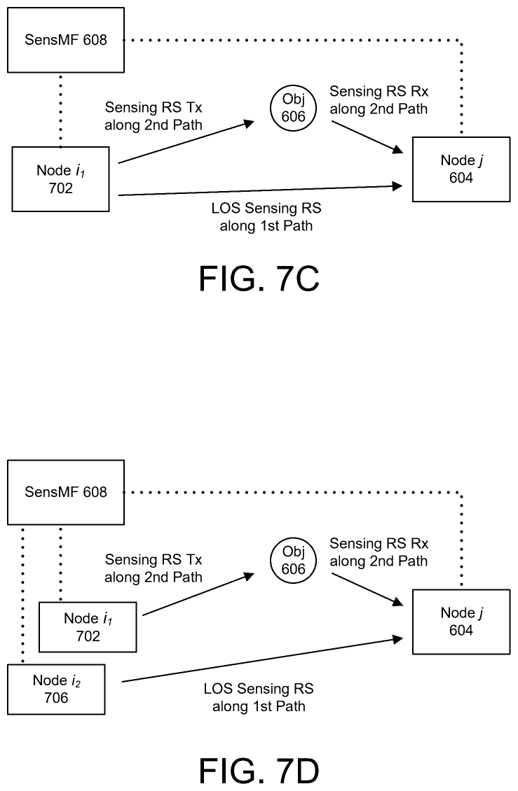

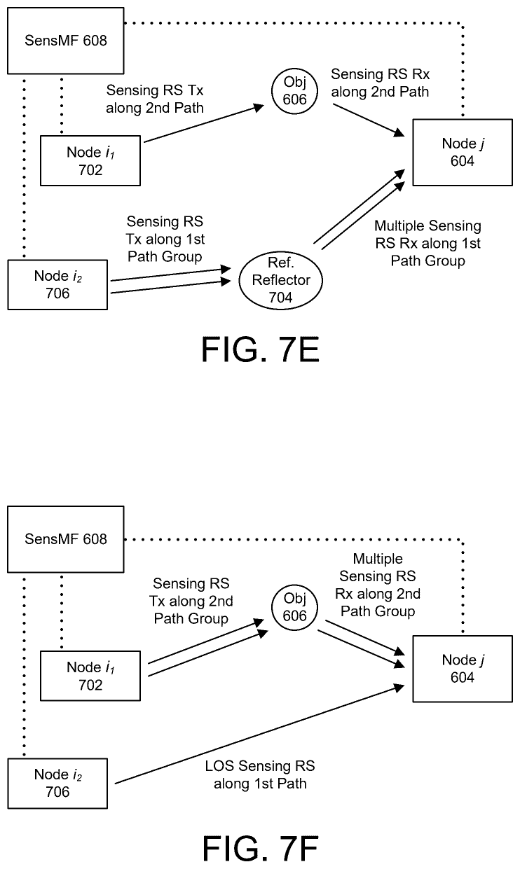

Considers the sensing measurement setup at the Node j 604 based on the sensing signal transmission of Node i 602, wherein the sensing measurement values of ToF or ToA (designated “ToF/A”), are obtained once for a propagation path 610 associated with a sensing target, and once for another propagation path 612. Then, for a measured difference of the ToF/A of the path associated with the sensing target (i.e., the target object 606) and the propagation path 612, the impact of constant time/clock error/mismatch at the node j is eliminated. Note that the propagation path 612 may be a non-line-of-sight (NLoS) path associated with a reflection from a known reflector 614. However, in other embodiments, the propagation path 612 is a LoS path from the Node i 602 to the Node j 604. The potential configurations for the sensing scenario 600 are described in greater detail with reference to FIGS. 7A-7F.

By relying on the difference of the sensing measurements of different paths, the error bound of the loss function defined in Equation 9 is reduced, considering the ToF measurements, expressed as

$$Error = 𝔼 \{ {W}_{⊤} ‖ T \tilde{o} {F}_{j} ( {p}_{obj} , {p}_{i} , t ) - T \tilde{o} {F}_{j} ( {p}_{obj} , {p}_{{i}^{′}} , t ) - \qquad Eq . 10$$

$${ToF ( {p}_{obj} , {p}_{i} , {p}_{j} ) - ToF ( {p}_{obj} , {p}_{j} , {p}_{i} ) ‖}_{2} \} \geq 𝔼 \{ {W}_{⊤} {‖ + {n}_{T , j} ( t ) + {n}_{T , i} ( t ) ‖}_{2} \}$$

and considering doppler shift measurements as:

$$Error = 𝔼 \{ {W}_{D} ‖ {\tilde{f}}_{D , j} ( {p}_{obj} , {v}_{obj} , {p}_{i} , {v}_{i} , t ) + \qquad Eq . 11$$

$${\tilde{f}}_{D , i} ( {p}_{obj} , {v}_{obj} , {p}_{j} , {v}_{j} , t ) - {f}_{D} ( {p}_{obj} , {v}_{obj} , {p}_{i} , {v}_{i} , {p}_{j} , {v}_{j} ) -$$

$${f}_{D} ( {p}_{obj} , {v}_{obj} , {p}_{j} , {v}_{j} , {p}_{i} , {v}_{i} ) \} \geq 𝔼 \{ {W}_{D} {‖ + {n}_{D , j} ( t ) + {n}_{D , j} ( {t}^{′} ) ‖}_{2} \}$$

The above observation provides a concept to counteract the impact of unknown but constant synchronization mismatches for sensing and/or positioning measurements within a wireless network.

According to embodiments of a first solution, a SensMF discovers and/or selects and/or configures a group of radio nodes for performing sensing signal transmission and sensing signal reception and measurements. Here, the group of radio nodes includes at least: one or multiple sensing Tx nodes i₁ . . . i_{T} for sensing signal transmission; and one or multiple sensing Rx nodes j₁ . . . j_{R} for sensing signal reception and/or sensing signal measurement and/or sensing measurements reporting.

The sensing signal measurements are based on, at least in part, the sensing signal transmissions of one or multiple of the sensing Tx nodes and received by the one or more sensing Rx nodes. According to the first solution, the sensing measurement and/or sensing measurement report of a sensing Rx node j comprises an estimate of the difference of measurable values, i.e., ΔV, can be expressed as:

$$Δ V = V ( M , {i}_{1} , {p}_{1} , {s}_{1} , {t}_{1} ) - V ( M , {i}_{2} , {p}_{2} , {s}_{2} , {t}_{2} ) \qquad Eq . 12$$

where V is the value of is the value of a measurement/phenomena observable by a sensing Rx node (e.g., a ToA of 1 μsec after the beginning of a subframe containing a configured sensing signal at the sensing Rx node j).

In the above equation, M is a sensing measurement type conducted at the sensing Rx node (e.g., a ToA. ToF, Reference Signal Time Difference (RSTD), Doppler shift, RSRPP, AoA, ZoA, etc.), i₁,i₂ each represent an index (or identifier (ID)) of the sensing Tx nodes (can be same or different radio nodes) for transmission of one or more sensing signals (e.g., sensing Tx node may be a UE, a gNB-TRP, a RAN node, an NCR, an IAB node, etc.). The parameters p₁,p₂ represent the propagation paths (or propagation path groups) starting from (similar or different) sensing Tx nodes and ending at (similar or different) sensing Rx nodes. Each propagation paths p₁,p₂ may correspond to a path with a LoS condition between the transmission and reception nodes or with a NLoS condition (e.g., blocked by an object, reflected from an object, scattered, refracted by an object, or a combination thereof).

In the above equation, s₁,s₂ each represent an index (or ID) of the configured sensing signals (of the same or different sensing Tx nodes), e.g., a resource ID, a resource set ID, etc., of a DL, or UL, or sidelink (SL) sensing signal. For example, the index/ID of s₁,s₂ may indicate one or more of a DL sensing RS, an UL sensing RS, a SL sensing RS, a DL PRS, a SL PRS, a CSI-RS, an UL SRS, a demodulation RS (DMRS), or DL/UL/SL data/control channels. In some examples, the sensing Tx node (e.g., a TRP ID/position) of a sensing signal or parameters associated with it may be known to the sensing Rx node. The parameters t₁,t₂ each represent the (same/similar or different) time/occasion or time instance or time window/duration (or a combination thereof) parameters associated with the sensing signal used for sensing measurements, or a time/instance/occasion for which the sensing measurement is performed or the value of V or ΔV is generated.

In some embodiments, path association at a sensing Rx node may be done for one or more propagation paths. For example, the sensing measurement of sensing Rx node may comprise an identification of one or multiple paths, wherein the propagation paths may include: A) Propagation paths associated with a sensing target and/or a sensing target area of interest; B) Paths associated with a direct/LoS propagation condition (blocked or non-blocked) from one or multiple sensing Tx nodes; or C) Propagation paths associated with a reflection from a known reflector (e.g., an NCR, or Reconfigurable Intelligent Surface (RIS)) or a known object (e.g., a metallic car with a known position and/or reflection characteristics). As used herein the term known (i.e., known object, known reflector, known path, known position, known velocity, etc.) is intended to cover the situations where an information is known to the sensing measurement node j, the SensMF, or both, and is not restricted to any individual interpretation within the present disclosure.

Note that a blocked LoS path experiences a reduction in the energy on the observed path (i.e., based on the blockage type), but the blockage effect does not eliminate the path for the receiver. The blocked line of sight (LOS) path can be distinguished from a non-blocked LOS path via the difference in pathloss or received reference signal received power (RSRP) or RSRPP of the path with an indicated threshold. In one example, such threshold is determined and indicated by the network to the UE based on one or more of the UE position information (e.g., a non-RAT dependent, global navigation satellite system (GNSS), UE position provided by the UE), UE distance to the transmitter radio node, transmission power of the sensing signal, etc. In some examples, the LOS non-blocked or blocked condition is differentiated by the UE based on the comparison with other/previous instances of a detected LOS condition.

Moreover, the blocked or non-blocked LOS path can be differentiated from other non-LOS/reflective paths via the arrival time, e.g., the paths other than, or with larger delay (with an indicated delay distance, e.g., of 10 nsec) from the first detected arrival path may be determined as reflective paths/NLoS paths. In some examples, a propagation path is detected to be a blocked LOS path if the path is determined to be the first arrival path (with minimal delay), but not the strongest received path, or below an indicated threshold of power, or below an indicated threshold of relative power (e.g., less than 0.1 of total received power of the received sensing signal, less power than each of the next two arrival paths).

In some embodiments, the identification of a path or a path group associated with a sensing target or target area of interest is performed by the sensing node according to an indicated description of the path (by the SensMF to the measurement node) or a known (e.g., via the application information of a UE) description of the path. In other words, the path association may be done based on one or more of the following descriptors.

In certain embodiments, the path association is performed based on the propagation time/delay characteristics. For example, based on the propagation delay of the path according to a known time reference by the sensing node (e.g., a global or a local clock or time reference), or a time reference generated from another local measurement (e.g., reception time of another known signal), or a reception time of a known path or a path with blocked or non-blocked LoS condition, or the first arrival path of a known transmission (e.g., sensing signal from a known transmitter), or a combination thereof.

In certain embodiments, the path association is performed based on the propagation path direction. For example, based on reflection point position information according to a known coordinate system or location reference by the node, or based on angular information (e.g., AoA, ZoA) according to a known coordinate system at the sensing node, or according to a known reference direction at the sensing node (e.g., according to a reception angle of another known signal and/or another known path (e.g., received LoS path).

In certain embodiments, the path association is performed based on the movement/mobility pattern associated with the propagation path. For example, based on a doppler frequency shift/difference of the path compared to a known frequency reference at the sensing node (e.g., according to another received signal or another measured path at the node) or according to a known doppler frequency/frequency shift of another path or measurement available at the sensing node.

In certain embodiments, the path association is performed based on the energy/power associated with the propagation path. For example, based on the RSRPP of the path or sum-RSRPP of group of paths associated with the target/target area.

In certain embodiments, the path association is performed according to pattern describing a group of paths wherein the path is a member of the group of paths. For example, based on the collection of paths reflected from an object with a known size/shape/RCS characteristic, or based on an indication that the path will be part of a group of paths with an indicated angular spread at the receiver, or reflected from a target of an indicated shape/size/RCS value.

In certain embodiments, the path association is performed based on a relative description of any of the above to a previous measurement and/or a previously measured or identified/detected path at the sensing Rx node (e.g., a reported path measurement ID) or object (e.g., an object ID) or object type (e.g., a human) or a known path (e.g., a LoS path associated with a sensing Tx node or sensing signal measurement known by the sensing Rx node). For example, based on paths detected according to an RSRPP increase and/or decrease of above an indicated threshold relative to a previous measurement of the sensing Rx node (at a previous measurement snapshot and/or based on a different indicated (or configured) sensing signal) and/or within an indicated (e.g., +/−30 degrees of) the angular distance (from the azimuth, zenith, or joint azimuth and elevation perspective) of the detected LoS path of a measurement at the sensing Rx node.

In some embodiments of the above, description of the target (or a subset thereof) may be communicated via sending an index from a known codebook to the sensing measurement node, wherein the codebook includes different possible target types, patterns of path delay/doppler/angle margins, etc., e.g., a propagation delay of [1-3 nsec], doppler shift of [20-40 Hz], AoA of [20-40 degrees] according to a known coordinate system and/or a reference of time, frequency, etc., at the receiver.

In some embodiments, the description of the paths or path groups are provided to the sensing Rx node (i.e., measurement node) relative to a second/known path to the sensing Rx node.

FIGS. 7A-7F illustrate various examples of potential configurations for the measurement of ΔV, with respect to the involved sensing Tx node(s), the sensing signals used, and the propagation paths measured, in accordance with aspects of the present disclosure. The radio nodes may be configured by the SensMF 608 to perform a sensing operation to derive sensing information regarding the target object 606.

FIG. 7A depicts a first potential configuration for the measurement of ΔV, comprising two radio nodes, i.e., a first sensing Tx node (denoted “Node i₁”) 702 and the Node j 604, and further involving a reference reflector 704. The Node j 604 (e.g., a UE or a gNB TRP) is configured by the SensMF 608 to perform sensing measurements (e.g., measuring ToA, AoA, ZoA of a sensing signal from a respective path, measuring doppler frequency shift experienced from a path) on at least two measurement paths based on one or more of sensing signals configured by the SensMF 608 to be transmitted by the Node i₁ 702 (e.g., a gNB TRP or a UE).

In the embodiments of FIG. 7A, a first measurement path (or path group) is associated with a reflection/re-transmission from the reference reflector 704 (a known object or entity) of a sensing signal transmitted by the Node i₁ 702, while a second measurement path (or path group) is associated with a sensing target or a sensing target area, i.e., a reflective path (from the Node i₁ 702) associated with the target object 606. Here, the reflection/re-transmission from the reference reflector 704 may be, e.g., a reflection caused by a RAN node (e.g., a RIS) or a re-transmission caused by a RAN node (e.g., an NCR), or a reflection from an unknown object for which the propagation path caused by the reflection is previously measured.

FIG. 7B depicts a second potential configuration for the measurement of ΔV, comprising three radio nodes, i.e., the Node i₁ 702, a second sensing Tx node (denoted “Node i₂”) 706, and the Node j 604, and further involving the reference reflector 704. The sensing Node j 604 is configured by the SensMF 608 to perform sensing measurements on at least two paths based on one or more of sensing signals configured by the SensMF 608 to be transmitted by the Node i₁ 702 and one or more of sensing signals configured by the SensMF to be transmitted by the Node i₂ 706 (e.g., a gNB TRP or a UE).

In the embodiment of FIG. 7B, the first measurement path (or path group) is associated with a reflection/re-transmission by the reference reflector 704 (a known object or entity) of a sensing signal transmitted by the Node i₂ 706, while the second measurement path (or path group) is associated with a sensing target or a sensing target area, i.e., a reflective path (from the Node i₁ 702) associated with the target object 606. Here, the reflection/re-transmission from the reference reflector 704 may be, e.g., a reflection caused by a RAN node (e.g., a RIS) or a re-transmission caused by a RAN node (e.g., an NCR), or a reflection from an unknown object for which the propagation path caused by the reflection is previously measured.

FIG. 7C depicts a first potential configuration for the measurement of ΔV, comprising two radio nodes, i.e., the Node i₁ 702 and the Node j 604. The Node j 604 is configured by the SensMF 608 to perform sensing measurements on at least two paths based on one or more of sensing signals configured by the SensMF 608 to be transmitted by the Node i₁ 702 (e.g., a gNB TRP or a UE), where the first measurement path (or path group) is associated with a LoS propagation condition from the Node i₁ 702 to the Node j 604, while the second measurement path (or path group) is associated with a sensing target or a sensing target area, i.e., a reflective path (from the Node i₁ 702) associated with the target object 606. In certain embodiments, the first measurement path is associated with a blocked LoS condition, while in other embodiments the first measurement path is associated with a non-blocked LoS condition.

FIG. 7D depicts a second potential configuration for the measurement of ΔV, comprising three radio nodes, i.e., the Node i₁ 702, the Node i₂ 706, and the Node j 604. The Node j 604 is configured by the SensMF 608 to perform sensing measurements on at least two paths based on one or more of sensing signals configured by the SensMF 608 to be transmitted by the Node i₁ 702 and one or more of sensing signals configured by the SensMF 608 to be transmitted by the Node i₂ 706, where the first measurement path (or path group) is associated with a LoS propagation condition from the Node i₂ 706 to the Node j 604, while the second measurement path (or path group) is associated with a sensing target or a sensing target area, i.e., a reflective path (from the Node i₁ 702) associated with the target object 606. In certain embodiments, the first measurement path is associated with a blocked LoS condition, while in other embodiments the first measurement path is associated with a non-blocked LoS condition.

In some embodiments, the Node j 604 is configured to derive/estimate and/or report a configured ΔV based on the obtained sensing measurements of at least two paths (or path groups). In some examples, the Node j 604 is configured to detect the propagation path associated with the sensing target according to a configured/indicated criteria, e.g., when RSRPP of a path satisfying an indicated set of conditions (e.g., on the AoA/ZoA etc.) is above an indicated threshold, and upon detection of the path, the Node j 604 is further configured to measure and report a ΔV.

FIG. 7E depicts a second potential configuration for the measurement of ΔV, comprising three radio nodes, i.e., the Node i₁ 702, the Node i₂ 706, and the Node j 604, and further involving the reference reflector 704. The sensing Node j 604 is configured by the SensMF 608 to perform sensing measurements on at least a first propagation path group (i.e., comprising multiple related propagation paths) and a second propagation path (or path group) based on one or more sensing signals configured by the SensMF 608 to be transmitted by the Node i₁ 702 and the Node i₂ 706. In the embodiment of FIG. 7E, the configured sensing measurement of the Node j 604 (e.g., comprising multiple measurements corresponding to the first path group) is performed based on a previously conducted measurement on an indicated path group, or the measurement of a priori known path group description. Further, the Node j 604 is configured to derive/estimate and/or report a configured ΔV based on the obtained sensing measurements.

FIG. 7F depicts a second potential configuration for the measurement of ΔV, comprising three radio nodes, i.e., the Node i₁ 702, the Node i₂ 706, and the Node j 604. The sensing Node j 604 is configured by the SensMF 608 to perform sensing measurements on at least a first propagation path (or path group) and a second propagation group (i.e., comprising multiple related propagation paths) based on one or more sensing signals configured by the SensMF 608 to be transmitted by the Node i₁ 702 and the Node i₂ 706. In the embodiment of FIG. 7F, the configured sensing measurement of the Node j 604 (e.g., comprising multiple measurements corresponding to at least the second path group) includes detection of a path group associated with a sensing target and/or performing a sensing measurement based on the detected path group. Further, the Node j 604 is configured to derive/estimate and/or report a configured ΔV based on the obtained sensing measurements.

In some embodiments, (e.g., a combination of the configurations shown in FIG. 7E and FIG. 7F) the measurements of the Node j 604 are performed based on two or more of path groups (e.g., a first path group associated with the sensing target, and a second path group associated with a known reflector) and wherein the Node j 604 is configured to derive/estimate and/or report a configured ΔV based on the obtained sensing measurements of the at least two path groups. Note that while FIGS. 7E and 7F depict multiple sensing Tx nodes (i.e., the Node i1 702 and the Node i2 706), in other embodiments the depicted sensing tasks may be performed using a single sensing Tx node, i.e., where the Node i1 702 and the Node i2 706 are the same sensing Tx node.

In various embodiments of the present disclosure, the sensing transmission of a sensing Tx node comprises two signals fully or partially separated via, e.g., different times (i.e., time-division multiplexed), difference sequences (i.e., code-division multiplexed), different frequency resources (i.e., frequency-division multiplexed) or a combination thereof, or only separated via different transmission beams. In such embodiments, the first signal transmission may be directed/aligned with a path associated with a sensing target, and the second path may be directed/aligned with LoS path between the sensing Tx node and a sensing Rx node. In certain embodiments, the sensing Rx node is further configured to perform time/doppler difference measurements based on the indication of the two signals (separate signal parameter configurations). In some such embodiments, a measured difference (or mismatch) of the transmissions of two sensing signals may be further indicated to the SensMF 608. For example, the sensing Rx node may report a timing misalignment between the two sensing signal transmissions from two beams or at different bands, etc.

In some embodiments of any of the above embodiments and configurations of FIGS. 7A-7F, both first path/path group and the second path/path group may be unknown to the SensMF 608 and/or to the Node j 604. In other words, both path references of ΔV are unknown, but reported. This situation is similar to having an additional equation of multiple unknown variables, which serves to collectively (i.e., with other equations and/or measurements) resolve the variable set. In such embodiments, the Node j 604 may be configured to derive and/or estimate and/or report a configured ΔV based on the obtained sensing measurements of the at least two path groups. For example, the detected paths within a first angular range/margin, or delay range/margin, or doppler range/margin may be considered as the first detected path/path group, while the detected paths within a second angular/delay/doppler range/margin may be considered as the second detected path/path group.

In some embodiments of any of the above embodiments and configurations of FIGS. 7A-7F, the first measurement (associated with a first path or path group) may be conducted at a first time instance t₁ (e.g., a first frame/subframe number X) and the second measurement (associated with a first path or path group) may be conducted at a second time instance t₂ (e.g., a second frame/subframe number Y). In other words, the differential sensing measurement (i.e., ΔV) may be based on measurements performed at different time instances. In such embodiments, the Node j 604 is configured to derive and/or estimate and/or report a configured ΔV based on the obtained sensing measurements of the at least two path groups of time instances t₁ and t₂.

In various embodiments of the present disclosure, to perform the sensing measurement of a path group, a sensing Rx node may be configured by the SensMF to apply an indicated function on the measurements of paths belonging to the path group. In some embodiments, such function may include one or more of: A) a (weighted) sum or averaging with an equal or given weight sequence over an indicated domain (average or sum of power/RSRPP, doppler shift, delay, etc. of the paths belonging to the path group), B) a window function (to generate a weighted sum of the individual paths belonging to the path group), C) maximum distance of the detected paths over an indicated domain (maximum difference of paths in their delay, ToA, AoA, ZoA, doppler shift, etc.), D) variance/spread of the detected paths over an indicated domain (to generate a weighted sum of the individual paths belonging to the path group), E) a computational model indicated to the Node j 604, e.g., defined via an artificial intelligence and/or machine learning (AI/ML) model indicated by the network or trained at the Node j 604 (or a combination thereof), or F) a combination of two or multiple of the above, where the combination may include the composition and/or cascading, algebraic summation, subtraction or two or more of the above functions. In other words, the reported sensing measurement may be based on the summation or averaging of one or more path group measurements.

In some embodiments, the reporting of a measurement performed over an identified path by a sensing Rx node (i.e., the measurement node) to the SensMF may further accompany an indication of the associated target/target area, e.g., a label. Beneficially, the indication/label may assist the SensMF to track the path modifications over time. As an example, the indication may include one or more of: a label, an object ID, a path ID, a path group ID accompanied with an RSRPP measurement of a path associated with the indicated object ID or path group ID, or a path description.

In some embodiments, when a sensing measurement report includes difference of two path measurements, the measurement report may include the label (or ID or description) of the first path (or first path group) and/or the label/ID/description of the second path (or second path group) for which the sensing measurement (as the difference of two measured values) is reported.

In some embodiments, a configured sensing Rx node detects a path with LoS (non-blocked) propagation condition among propagation paths (at the current or previous or indicated set of time instances) towards two or more sensing transmitters (e.g., with a configured sensing signal transmission). In such embodiments, the differential sensing measurement (ΔV) of the sensing Rx node may be calculated based on the detected/selected LoS path (i.e., between the sensing Rx node and a sensing Tx node determined by the sensing Rx node among a set of indicated sensing Tx nodes by the SensMF) as the first path and a second path/path group associated with a sensing target. The sensing Rx node reports (i.e., to the SensMF) the ΔV together with indication of the chosen/determined sensing Tx node and/or an indication of a sensing signal ID for which the LoS condition is detected.

In some embodiments, the SensMF indicates to the sensing Rx node a set of sensing signals, sensing Tx nodes, candidate/recommended sensing Tx nodes or signals, or a combination thereof, among which the sensing Rx node shall or (in some other embodiments) can (e.g., when a list of sensing Tx nodes is a recommendation list for LoS determination) determine a propagation path, as the first path, for performing the differential sensing measurement ΔV.

In some embodiments, the SensMF further indicates to the sensing Rx node at least one criterion for determination of the first propagation path among multiple indicated (or known) sensing Tx nodes and/or sensing signals at the current or previous time instances. The at least one criterion may relate to: A) the detection of a LoS non-blocked propagation condition; B) the detection of a LoS propagation condition as first arrival path (including blocked LoS path) with an RSRPP of above an indicated threshold; C) the detection of a propagation path within a time window (e.g., not older than 1 second); D) the detection of a path for which a condition holds for a time window (e.g., a stable condition for a reference/first measurement path); E) a preference, recommendation, or order for criteria checking among the sensing Tx nodes and/or sensing signals; or F) a combination thereof.

In some embodiments, if one of the paths for which the associated measurement difference is to be reported is a priori known by the SensMF (e.g., LoS path between the sensing Tx node and a sensing Rx node) and configured by the SensMF (for the measurement of the sensing Rx node), then the sensing Rx node only reports the ID/label of the propagation path corresponding to a path which is not a priori known by the SensMF.

In one implementation of the above, the sensing Rx node is configured to report a difference of a detected path ToA measurement (e.g., detected path associated with a target area) with a ToA measurement of a LoS path received from a sensing Tx node, where the path detection is performed at the sensing Rx node by comparing the RSRPP of a path within an indicated range of angle (AoA/ZoA) to an indicated threshold (among multiple indicated range of angles and one or multiple RSRPP threshold values to the sensing Rx node). In this example, upon detection of a path (via a measured RSRPP comparison to the indicated threshold) within the m-th configured/indicated sensing target groups (e.g., via an m-th range of AoA, ZoA, doppler shift, etc.), the sensing Rx node reports the difference of the measured ToA of the detected path with the indicated LoS path, together with the indication of the index m.

In some embodiments, a report containing a measured ΔV may further contain path condition information indicating the condition of at least one of the paths used to measure the ΔV. For example, the path condition information may indicate whether a particular path is in the LoS condition and if it is blocked/not-blocked, as well as the RSRPP associated with each of the paths. In some embodiments, the reported indication of a condition (or criteria for determination) of the two paths is done based on the prior indication or configuration of the SensMF. For example, the reporting may be based on whether a path for which a configured differential measurement is conducted has a non-blocked LoS condition, corresponds to an RSRPP of a higher than an indicated threshold, is stable, etc. As used herein, path “stability” is determined based on the variation/difference of characteristic(s) over time. For example, a path may be considered “stable” when the amount of variation/difference within (i.e., less than) an indicated threshold, e.g., including a variation/difference level and a time window.

In some embodiments, a sensing measurement configuration and/or sensing signal transmission configuration of a node is defined with dependency to a previously performed sensing measurement. For example, a subset of one or multiple configuration parameters for the sensing signal reception and measurement (and/or sensing signal transmission) of a sensing node may be determined by the sensing node (or indicated implicitly by the SensMF) based on one or multiple parameters obtained/estimated by the sensing node from one or multiple previous measurements. Such dependency may be useful for tracking and/or computing some of the configuration parameters at the sensing Rx node based on previous measurement values.

In one example, the parameters defining a path group associated with a sensing target (e.g., permissible angular range or ToA range) are indicated by the SensMF to be determined by the sensing Rx node based on one or more of: a prior estimation of the path group parameters (e.g., a previous estimate of the average ToA, ToA spread (e.g., distance and/or variance), a difference of the current measurement time instance and the time instance of the previously conducted measurement, and/or an indicated ambiguity parameter. In such embodiments, the sensing Rx node may use an indicated function (or computational model) to compute the parameters of the updated path group based on the input parameters.

In some embodiments, the value of ΔV is computed at the sensing Rx node and is reported either to the SensMF or to a node configured by the SensMF to perform further computation of the sensing measurement values. In other words, a measured ΔV value may be reported separately, or may be combined with other ΔV values, such that the configured node reports an aggregated ΔV to the SensMF. In some other embodiments, the separate configured path measurements are performed at the sensing Rx node and separately communicated/reported to a second node (a SensMF, a UE or a RAN node capable of performing computation on the received sensing measurements).

In some embodiments, any of the configurations (of a sensing signal, a sensing transmission, sensing reception, sensing measurement) and/or indications and/or reporting information elements between a sensing node and the SensMF or a subset thereof are: 1) received by the sensing Rx nodes, 2) transmitted by the sensing Rx nodes, 3) received by the sensing Tx nodes, 4) transmitted by the sensing Tx nodes; 5) transmitted and/or received by the SensMF node, or any combination thereof.

In certain embodiments, the configurations and/or indications and/or reporting information elements may be communicated via the UL, DL or SL physical data and/or control channels defined within the communication network, e.g., NR physical broadcast channel (PBCH), physical downlink shared channel (PDSCH), physical downlink control channel (PDCCH), physical uplink shared channel (PUSCH), physical uplink control channel (PUCCH), physical sidelink broadcast channel (PSBCH), physical sidelink control channel (PSCCH), physical sidelink shared channel (PSSCH), via a higher layer (MAC Control Element (MAC-CE) or RRC) signaling, e.g., where the sensing Rx node and/or the sensing Tx node is a UE.

In certain embodiments, the configurations and/or indications and/or reporting information elements may be communicated via a logical interface between the SF and the Sensing nodes, as part of the LTE Positioning Protocol (LPP) or as modified/enhanced LPP message framework for sensing or as an interface defined for sensing message exchanges over the N1 interface between the SF and a UE, e.g., where the sensing Tx node and/or sensing Rx node is a UE.

In certain embodiments, the configurations and/or indications and/or reporting information elements may be communicated via a logical interface between the SensMF and the Sensing nodes, as part of the NR Positioning Protocol annex (NRPPa) (or modified/enhanced NRPPa message framework for sensing) or as an interface defined over the Next Generation Application Protocol (NGAP) interface, e.g., where the sensing Tx and/or sensing Rx node is a TRP of RAN and the SensMF is a core network function (SF, LMF, etc.).

In certain embodiments, the configurations and/or indications and/or reporting information elements may be communicated via a logical interface between the SensMF and the Sensing nodes, e.g., where the SensMF is a serving gNB of a sensing task and the sensing node is a UE or a TRP of the RAN. In some examples, the interface utilizes (at least in part) the X2 interface between the associated gNB of the sensing node and the serving gNB that controls/coordinates the sensing task.

According to embodiments of a second solution, the SensMF configures one or multiple UE nodes for performing sensing measurements based on one or more of DL sensing signal transmissions (DL PRS, CSI-RS, DL DMRS, DL PDSCH, DL PDCCH, DL SSB/SSS/PBCH, etc.), SL sensing signal (e.g., a SL PRS, SRS, etc., SL data/control channels) transmissions, or a combination thereof. In some embodiments, the one or multiple UEs (or a subset thereof) may not necessarily have a tight synchronization with the network/known anchor nodes.

According to the second solution, the configuration of sensing measurements and/or reporting of the one or multiple UEs may include, among others, the DL RSTD of paths, the DL Reference Signal Doppler Difference (RSDD) of paths, the DL Reference Signal Angular Difference (RSAD) of paths (i.e., referring to the RS AoA and/or ZoA differential), the SL RSTD of paths, the SL RSDD of paths, the SL RSAD of paths, the SL-DL (XL) RSTD of paths, the XL RSDD of paths, the XL RSAD of paths, or a combination of one or multiple of the above. The above quantities are described in Tables 1-9.

TABLE 1
DL reference signal time difference of paths (DL RSTD)

| | |
|---|---|
| Definition | Is the DL relative timing difference between the DL propagation path P originating from |
| | Transmission Point (TP) j and the DL propagation path Q originating from reference |
| | TP i, defined as T_{SubframeRxj, P} − T_{SubframeRxi, Q}, |
| | Where: |
| | T_{SubframeRxj, P} is the time when the UE receives the start of one subframe from the |
| | propagation path P originating from TP j. |
| | T_{SubframeRxi, Q} is the time when the UE receives the corresponding start of one subframe |
| | from the propagation path Q originating from TP i that is closest in time to the subframe |
| | received from the propagation path P originating from TP j. |
| | Multiple DL RS (e.g., DL PRS, CSI-RS, etc.) resources of a TP can be used to determine |
| | the start of one subframe from a propagation path originating from the TP. |
| Applicable | RRC_CONNECTED, |
| for | RRC_INACTIVE and/or RRC_IDLE |

TABLE 2
DL reference signal doppler shift difference of paths (DL RSDD)

| | |
|---|---|
| Definition | Is the difference of experienced doppler frequency shift between the DL propagation |
| | path P originating from Transmission Point (TP) j and the DL propagation path Q |
| | originating from reference TP i, defined as D_{Rxj, P} − D_{Rxi, Q}, |
| | Where: |
| | D_{Rxj, P} is the doppler frequency shift by which the UE receives one or multiple RSs from |
| | the propagation path P originating from TP j. |
| | D_{Rxi, Q} is the doppler frequency shift by which the UE receives one or multiple RSs from |
| | the propagation path Q originating from TP i. |
| | Multiple DL RS (e.g., DL PRS, CSI-RS, etc.) resources of a TP can be used to |
| | determine/estimate the doppler shift of a propagation path originating from the TP. |
| Applicable | RRC_CONNECTED, |
| for | RRC_INACTIVE and/or RRC_IDLE |

TABLE 3
DL reference signal angle-of-arrival difference of paths (DL RSAD)

| | |
|---|---|
| Definition | Is the DL relative angle of arrival difference between the DL propagation path P |
| | originating from Transmission Point (TP) j and the DL propagation path Q originating |
| | from reference TP i, defined as A_{Rxj, P} − A_{Rxi, Q}, |
| | Where: |
| | A_{Rxj, P} is the AoA at the measuring UE of the propagation path P originating from TP j. |
| | A_{Rxi, Q} is the AoA at the measuring UE of the propagation path Q originating from TP i. |
| | Multiple DL RS transmission (e.g., DL PRS, CSI-RS, etc.) of a TP resources can be used |
| | to determine the AoA of a propagation path originating from the TP. |
| Applicable | RRC_CONNECTED, |
| for | RRC_INACTIVE and/or RRC_IDLE |

TABLE 4
SL reference signal time difference of paths (SL RSTD)

| | |
|---|---|
| Definition | Is the SL relative timing difference between the propagation path P originating from the |
| | UE Transmission Point (TP) j and the propagation path Q originating from reference UE |
| | TP i, defined as T_{SubframeRxj, P} − T_{SubframeRxi, Q}, |
| | Where: |
| | T_{SubframeRxj, P} is the time when the UE receives the start of one subframe from the |
| | propagation path P originating from UE TP j. |
| | T_{SubframeRxi, Q} is the time when the UE receives the corresponding start of one subframe |
| | from the propagation path Q originating from UE TP i that is closest in time to the |
| | subframe received from the propagation path P originating from UE TP j. |
| | Multiple SL or UL RS transmission (e.g., SL PRS, SRS, etc.) resources of a UE TP can |
| | be used to determine the start of one subframe from a propagation path originating from |
| | the UE TP. |
| Applicable | RRC_CONNECTED, |
| for | RRC_INACTIVE and/or RRC_IDLE |

TABLE 5
SL reference signal doppler shift difference of paths (SL RSDD)

| | |
|---|---|
| Definition | Is the difference of experienced doppler frequency shift between the propagation path P |
| | originating from UE Transmission Point (TP) j and terminated at the measuring UE and |
| | the propagation path Q originating from reference UE TP i, and terminated at the |
| | measuring UE defined as D_{Rxj, P} − D_{Rxi, Q}, |
| | Where: |
| | D_{Rxj, P} is the doppler frequency shift by which the UE receives one or multiple RSs from |
| | the propagation path P originating from UE TP j. |
| | D_{Rxi, Q} is the doppler frequency shift by which the UE receives one or multiple RSs from |
| | the propagation path Q originating from UE TP i. |
| | Multiple SL or UL RS transmission (e.g., SL PRS, SRS etc.) resources of a UE TP can |
| | be used to determine/estimate the doppler shift of a propagation path originating from |
| | the UE TP. |
| Applicable | RRC_CONNECTED, |
| for | RRC_INACTIVE and/or RRC_IDLE |

TABLE 6
SL reference signal angle-of-arrival difference of paths (SL RSAD)

| | |
|---|---|
| Definition | Is the relative angle of arrival difference between the propagation path P originating |
| | from UE Transmission Point (TP) j and terminated at the measuring UE and the |
| | propagation path Q originating from reference TP i and terminated at the measuring UE, |
| | defined as A_{Rxj, P} − A_{Rxi, Q}, |
| | Where: |
| | A_{Rxj, P} is the AoA at the measuring UE of the propagation path P originating from |
| | UE TP j. |
| | A_{Rxi, Q} is the AoA at the measuring UE of the propagation path Q originating from |
| | UE TP i. |
| | Multiple SL or UL RS transmissions (e.g., SL PRS, SRS etc.) resources of a UE TP can |
| | be used to determine the AoA of a propagation path originating from the UE TP. |
| Applicable | RRC_CONNECTED, |
| for | RRC_INACTIVE and/or RRC_IDLE |

TABLE 7
SL-DL reference signal time difference of paths (XL RSTD)

| | |
|---|---|
| Definition | Is the relative timing difference between the propagation path P originating from the UE |
| | Transmission Point (TP) j and the propagation path Q originating from reference RAN |
| | node (gNB, TRP, etc.) TP i, defined as T_{SubframeRxj, P} − T_{SubframeRxi, Q}, |
| | Where: |
| | T_{SubframeRxj, P} is the time when the UE receives the start of one SL subframe from the |
| | propagation path P originating from UE TP j. |
| | T_{SubframeRxi, Q} is the time when the UE receives the corresponding start of one DL subframe |
| | from the propagation path Q originating from gNB/TRP TP i that is closest in time to the |
| | subframe received from the propagation path P originating from UE TP j. |
| | Multiple SL or UL RS transmission resources can be used to determine the start of one |
| | subframe from a propagation path originating from a UE TP. |
| | Multiple DL RS transmission resources can be used to determine the start of one |
| | subframe from a propagation path originating from a gNB/TRP TP. |
| Applicable | RRC_CONNECTED, |
| for | RRC_INACTIVE and/or RRC_IDLE |

TABLE 8
SL-DL reference signal doppler shift difference of paths (XL RSDD)

| | |
|---|---|
| Definition | Is the difference of experienced doppler frequency shift between the propagation path P |
| | originating from UE Transmission Point (TP) j and terminated at the measuring UE and |
| | the propagation path Q originating from reference RAN node TP i, and terminated at the |
| | measuring UE defined as D_{Rxj, P} − D_{Rxi, Q}, |
| | Where: |
| | D_{Rxj, P} is the doppler frequency shift by which the UE receives one or multiple RSs in SL |
| | from the propagation path P originating from UE TP j. |
| | D_{Rxi, Q} is the doppler frequency shift by which the UE receives one or multiple RSs in DL |
| | from the propagation path Q originating from the RAN node TP i. |
| | Multiple SL or UL RS transmission resources can be used to determine/estimate the |
| | doppler shift of a propagation path originating from a UE TP. |
| | Multiple DL RS transmission resources can be used to determine/estimate the doppler |
| | shift of a propagation path originating from a RAN node TP. |
| Applicable | RRC_CONNECTED, |
| for | RRC_INACTIVE and/or RRC_IDLE |

TABLE 9
SL-DL reference signal angle-of-arrival difference of paths (XL RSAD)

| | |
|---|---|
| Definition | Is the relative angle of arrival difference between the propagation path P originating |
| | from UE Transmission Point (TP) j and terminated at the measuring UE and the |
| | propagation path Q originating from reference RAN node (gNB/TRP) TP i and |
| | terminated at the measuring UE, defined as A_{Rxj, P} − A_{Rxi, Q}, |
| | Where: |
| | A_{Rxi, P} is the AoA at the measuring UE of the propagation path P originating from |
| | UE TP j. |
| | A_{Rxi, Q} is the AoA at the measuring UE of the propagation path Q originating from |
| | RAN node TP i. |
| | Multiple SL or UL RS transmission resources can be used to determine the AoA of a |
| | propagation path originating from a UE TP. |
| | Multiple DL RS transmission resources can be used to determine the AoA of a |
| | propagation path originating from a RAN node TP. |
| Applicable | RRC_CONNECTED, |
| for | RRC_INACTIVE and/or RRC_IDLE |

In some embodiments of the DL/SL/XL RSDD measurements, the doppler shift of a path and/or difference of two doppler shifts of two paths based on transmission of two sensing signal/RSs at different carrier frequencies (e.g., in the measurement of a DL/SL/XL RSDD) are determined as a normalized value e.g., to the carrier frequency of the signal used to measure the doppler shift of the corresponding propagation path. In one such example, the DL/SL/XL RSDD is measured as D_{Rxj,P}/fcj−D_{Rxi,Q}/fci.

In some embodiments of the above-defined measurements, the doppler shift estimate can be further interpreted as the frequency estimate of a received signal, and not necessarily as a doppler shift of a transmitted signal.

In some embodiments of the defined DL/SL/XL RSAD measurements, the angle of arrival (as separate definitions or as interpretation of the stated DL/SL/XL RSAD) measured at a UE for determining the DL/SL/XL RSAD is azimuth of arrival, zenith of arrival, or an angle in a plane containing the direction of arrival of the path P originating from TP j and the direction of arrival of the path Q originating from TP i.

In some embodiments of the above-defined measurements, a propagation path may be indicated as a path from an indicated TP to the measuring UE with a LoS condition, first-arrival-path condition, a path detectable within an indicated delay-angle-doppler margin (e.g., based on the UEs local coordinate system and/or defined relatively with respect to another path, e.g., delay margin of 0-10 nsecs with respect to a first arrival path), a path with an RSRPP above an indicated threshold, or a combination thereof.

In some embodiments of the above-defined measurements, for FR1, the measurement reference point shall be the antenna connector of the UE. In some embodiments of the above-defined measurements, for FR2, the reference point shall be the antenna of the UE. For frequency range #3 (FR3) (i.e., all or a subset of the frequency band between 6-20 GHz), the reference point may be any of the antenna connector of the UE, the Rx antenna of the UE, the receiver branch connector of UE to the corresponding antennas.

In some embodiments of the above-defined SL and DL measurements, the TP i and TP j are the same. In some other embodiments, the TP i and TP j are different UE and/or network nodes.

In some embodiments of the above-defined measurements, the difference may be defined or measured as or reported as the absolute difference of the therein defined two measurements, or a function (absolute value, logarithm, square, etc.) of the measured difference.

In some embodiments of the above-defined measurements, the UE measurements are performed over the reference signal transmissions of the TP I and TP j which are separate in time, e.g., for N number of subframes, or a known/indicated time difference to the UE. In one such embodiments, when the measurement of DL/SL/XL RSTD is performed at the UE based on the transmission of TP i and TP j which is separated N DL subframes in time, the UE is required to subtract the known N subframe time difference from the measurement before reporting to the network.

Moreover, the configuration of sensing measurements and/or reporting of the one or multiple gNBs/TRPs may include, among others, the UL RSTD of paths, the UL Reference Signal Doppler Difference (RSDD) of paths, the UL RSAD of paths, the Inter-RAN RSTD of paths, the Inter-RAN RSDD of paths, the Inter-RAN RSAD of paths, or a combination of one or multiple of the above. These quantities are described in Tables 10-15.

TABLE 10
UL reference signal time difference of paths (UL RSTD)

| | |
|---|---|
| Definition | Is the UL relative timing difference between the UL propagation path P originating from |
| | Transmission Point (TP) j and the UL propagation path Q originating from reference |
| | TP i, defined as T_{SubframeRxj, P} − T_{SubframeRxi, Q}, |
| | Where: |
| | T_{SubframeRxj, P} is the time when the gNB/TRP receives the start of one subframe from the |
| | propagation path P originating from TP j. |
| | T_{SubframeRxi, Q} is the time when the gNB/TRP receives the corresponding start of one |
| | subframe from the propagation path Q originating from TP i that is closest in time to the |
| | subframe received from the propagation path P originating from TP j. |
| | Multiple UL RS transmission (e.g., UL SRS, etc.) resources of a TP can be used to |
| | determine the start of one subframe from a propagation path originating from the TP. |
| Applicable | RRC_CONNECTED, |
| for | RRC_INACTIVE and/or RRC_IDLE |

TABLE 11
UL reference signal doppler shift difference of paths (UL RSDD)

| | |
|---|---|
| Definition | Is the difference of experienced/caused doppler frequency shift between the UL |
| | propagation path P originating from Transmission Point (TP) j and the UL propagation |
| | path Q originating from reference TP i, defined as D_{Rxj, P} − D_{Rxi, Q}, |
| | Where: |
| | D_{Rxj, P} is the doppler frequency shift by which the gNB/TRP receives one or multiple RSs |
| | from the propagation path P originating from TP j. |
| | D_{Rxi, Q} is the doppler frequency shift by which the gNB/TRP receives one or multiple RSs |
| | from the propagation path Q originating from TP i. |
| | Multiple UL RS transmission (e.g., UL SRS, etc.) resources of a TP can be used to |
| | determine/estimate the doppler shift of a propagation path originating from the TP. |
| Applicable | RRC_CONNECTED, |
| for | RRC_INACTIVE and/or RRC_IDLE |

TABLE 12
UL reference signal angle-of-arrival difference of paths (UL RSAD)

| | |
|---|---|
| Definition | Is the UL relative angle of arrival difference between the UL propagation path P |
| | originating from Transmission Point (TP) j and the UL propagation path Q originating |
| | from reference TP i, defined as A_{Rxj, P} − A_{Rxi, Q}, |
| | Where: |
| | A_{Rxj, P} is the AoA at the measuring gNB/TRP of the propagation path P originating from |
| | TP j. |
| | A_{Rxi, Q} is the AoA at the measuring gNB/TRP of the propagation path Q originating from |
| | TP i. |
| | Multiple UL RS transmission (e.g., UL SRS, etc.) resources of a TP can be used to |
| | determine AoA of a propagation path originating from the TP. |
| Applicable | RRC_CONNECTED, |
| for | RRC_INACTIVE and/or RRC_IDLE |

TABLE 13
Inter-RAN reference signal time difference of paths (Inter-RAN RSTD)

| | |
|---|---|
| Definition | Is the Inter-RAN relative timing difference between the propagation path P originating |
| | from the RAN Transmission Point (TP) j and the propagation path Q originating from a |
| | reference RAN TP i, defined as T_{SubframeRxj, P} − T_{SubframeRxi, Q}, |
| | Where: |
| | T_{SubframeRxj, P} is the time when the gNB/TRP receives the start of one subframe from the |
| | propagation path P originating from RAN TP j. |
| | T_{SubframeRxi, Q} is the time when the gNB/TRP receives the corresponding start of one |
| | subframe from the propagation path Q originating from RAN TP i that is closest in time |
| | to the subframe received from the propagation path P originating from RAN TP j. |
| | Multiple Inter-RAN or DL RS transmission (e.g., DL PRS, CSI-RS, etc.) resources can |
| | be used to determine the start of one subframe from a propagation path originated from a |
| | RAN TP. |
| Applicable | RRC_CONNECTED, |
| for | RRC_INACTIVE and/or RRC_IDLE |

TABLE 14
Inter-RAN reference signal doppler shift difference of paths (Inter-RAN RSDD)

| | |
|---|---|
| Definition | Is the difference of experienced/caused doppler frequency shift between the propagation |
| | path P originating from RAN Transmission Point (TP) j and terminated at the measuring |
| | gNB/TRP and the propagation path Q originating from reference RAN TP i, and |
| | terminated at the measuring gNB/TRP defined as D_{Rxj, P} − D_{Rxi, Q}, |
| | Where: |
| | D_{Rxj, P} is the doppler frequency shift by which the measuring gNB/TRP receives one or |
| | multiple RSs from the propagation path P originating from RAN TP j. |
| | D_{Rxi, Q} is the doppler frequency shift by which the measuring gNB/TRP receives one or |
| | multiple RSs from propagation path Q originated from RAN TP i. |
| | Multiple Inter-RAN or DL RS transmission (e.g., DL PRS, CSI-RS, etc.) resources can |
| | be used to determine/estimate the doppler shift of a propagation path originating from a |
| | RAN TP. |
| Applicable | RRC_CONNECTED, |
| for | RRC_INACTIVE and/or RRC_IDLE |

TABLE 15
Inter-RAN reference signal angle-of-arrival difference of paths (Inter-RAN RSAD)

| | |
|---|---|
| Definition | Is the relative angle of arrival difference between the propagation path P originating |
| | from RAN Transmission Point (TP) j and terminated at the measuring gNB/TRP and the |
| | propagation path Q originating from a reference RAN TP i and terminated at the |
| | measuring gNB/TRP, defined as A_{Rxj, P} − A_{Rxi, Q}, |
| | Where: |
| | A_{Rxi, P} is the AoA at the measuring gNB/TRP of the propagation path P originating from |
| | UE TP j. |
| | A_{Rxi, Q} is the AoA at the measuring gNB/TRP of the propagation path Q originating from |
| | UE TP i. |
| | Multiple Inter-RAN or DL RS transmission (e.g., DL PRS, CSI-RS, etc.) resources can |
| | be used to determine the AoA of a propagation path originating from a RAN TP. |
| Applicable | RRC_CONNECTED, |
| for | RRC_INACTIVE and/or RRC_IDLE |

The present disclosure is not limited to any of the single example, or solution, or embodiment, or implementation elements individually, and one or more elements of the above-mentioned may be combined to construct a new embodiment.

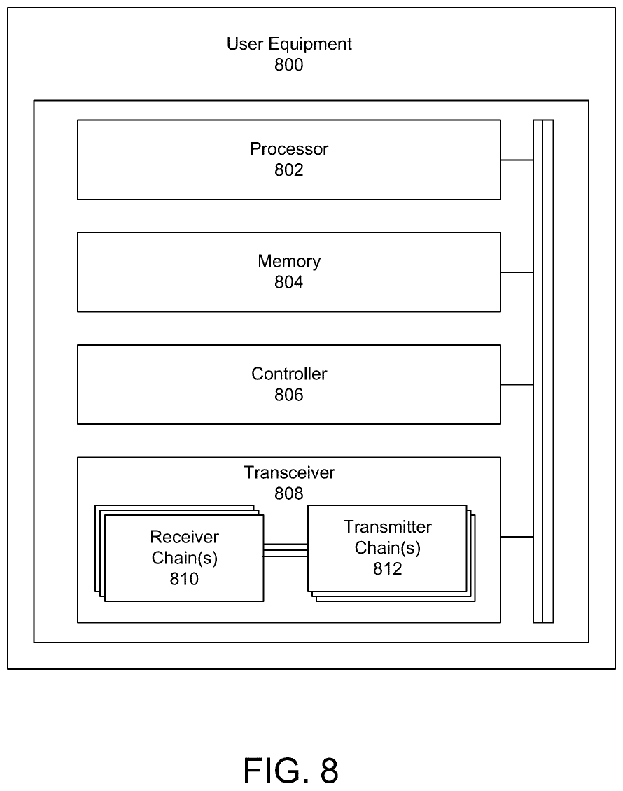

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a central processing unit (CPU), an ASIC, a field programmable gate array (FPGA), or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions that, when executed by the processor 802, cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the measurement node and/or radio sensing node functions described herein (e.g., executing, by the processor 802, instructions stored in the memory 804). For example, the processor 802 may support wireless communication at the UE 800 in accordance with examples as disclosed herein. The UE 800 may be configured to support a means for receiving a sensing configuration for sensing signal measurement and reporting, where the sensing configuration includes an indication of a first propagation path (i.e., p₁) and an indication of a second propagation path (i.e., p₂), where the first propagation path is associated with a sensing target (e.g., an object of interest or an area of interest).

In some embodiments, the UE 800 is configured to support a means for performing a first sensing measurement of the first propagation path in accordance with the sensing configuration. In some embodiments, the UE 800 is configured to support a means for performing a second sensing measurement of the second propagation path in accordance with the sensing configuration.

In some embodiments, the UE 800 is configured to support a means for transmitting a sensing measurement report including a differential sensing measurement (i.e., ΔV) based on the first sensing measurement and the second sensing measurement, where the differential sensing measurement indicates a difference in measured values associated with the first propagation path and the second propagation path, e.g., ΔV=V(p₁)−V(p₂), where V(p₁) and V(p₂) are values of the path measurements conducted of paths p₁ and p₂, respectively.

In certain implementations, the sensing configuration indicates one or more of: A) a time/frequency resource for transmitting the report; B) a condition for transmitting the report; C) a measurement type of the first sensing measurement; D) a measurement type of the second sensing measurement; or E) a combination thereof.

In certain implementations, the second propagation path is associated with a LoS path between the UE 800 and a sensing Tx node (i.e., sensing signal transmitter). In one embodiment, the second propagation path may include a re-transmission, e.g., from a NCR, an IAB node, etc. In certain implementations, the second propagation path is associated with a reflection path between the radio node including the UE 800 and a known reflector.

In certain implementations, the UE 800 is further configured to identify the first propagation path or the second propagation path based on one or more of: A) one or more propagation time/delay characteristics; B) a propagation path directional information; C) a pattern of movement associated with the first propagation path or the second propagation path; D) a power level associated with the first propagation path or the second propagation path; E) a path group, where the first propagation path or the second propagation path is a member of the path group; F) a relative description of an identified propagation path or a known propagation path; or G) a combination thereof. Note here that the path group may be defined with a certain value range of azimuth, zenith, doppler, delay (or a combination thereof).

In certain implementations, the first sensing measurement and the second sensing measurement are further associated with one or more of: A) a same measurement time; B) a same measurement type; C) a same sensing signal; D) a same sensing transmitter (i.e., same sensing Tx node); or E) a combination thereof. In certain implementations, the first sensing measurement and the second sensing measurement are further associated with one or more of: A) a different measurement time; B) a different measurement type; C) a different sensing signal; D) a different sensing transmitter (i.e., different sensing Tx node); or E) a combination thereof.

In certain implementations, the differential sensing measurement is based on at least one of: A) a DL reference signal time difference (RSTD) of the first propagation path and the second propagation path; B) a DL reference signal doppler difference (RSDD) of the first propagation path and the second propagation path; C) a DL reference signal angular difference (RSAD) of the first propagation path and the second propagation path; or D) a combination thereof.

In certain implementations, the differential sensing measurement is based on at least one of: A) a SL RSTD of the first propagation path and the second propagation path; B) a SL RSDD of the first propagation path and the second propagation path; C) a SL RSAD of the first propagation path and the second propagation path; or D) a combination thereof.

In certain implementations, the first propagation path is associated with a SL direction or a SL subframe, where the second propagation path is associated with a DL direction or a DL subframe, and where the differential sensing measurement is based on at least one of: A) a SL-and-DL (XL) RSTD of the first propagation path and the second propagation path; B) a XL RSDD of the first propagation path and the second propagation path; C) a XL RSAD of the first propagation path and the second propagation path; or D) a combination thereof.

In certain implementations, the sensing measurement report further indicates an association of the first propagation path or the second propagation path to one or more of: A) a previously indicated sensing target (e.g., reporting of a path is associated with a sensing target indicated to the measurement node); B) a path group, where the first propagation path or the second propagation path is a member of the path group; C) a previously reported propagation path (e.g., an indication that the reported path is the same as or continuation of a previously reported or indicated path, which may hold a different/updated value, such as an updated angle of a reflection path from a moving target object); or D) a combination thereof.

In certain implementations, the sensing measurement report further indicates a path condition including one or more of: A) a stability condition of the first propagation path or the second propagation path (e.g., not changing in delay, angle, doppler shift, RSRPP, or a combination thereof, potentially based on an indicated criteria (e.g., threshold for change) and type of the change (e.g., perceived path delay)); B) a LoS condition the second propagation path; C) a NLoS condition of the first propagation path or the second propagation path (e.g., blocked by an object, reflected from an object, scattered, refracted by an object, or a combination thereof); or D) a combination thereof. In further implementations, the UE 800 is further configured to indicate the path condition using an index of a codebook, where the codebook includes a set of predetermined path conditions (e.g., possible, a priori path conditions).

In certain implementations, the UE 800 is further configured to receive a set of candidate paths and select the second propagation path from the set of candidate paths, where the second propagation path is a reference path for the sensing signal measurement and reporting. Here, each candidate path is associated with a respective transmitter (i.e., sensing Tx node) or sensing signal, or both. In further implementations, the UE 800 is further configured to receive one or more criteria for the selection of the second propagation path.

In some embodiments, the UE 800 (e.g., acting as a sensing measurement node) may be configured to transmit information regarding its capability for sensing measurements to the SensMF. The capability information may include, but is not limited to, a type of the supported measurement, a supported time of measurements and/or reporting (e.g., the maximum supported duration of a sensing signal which can be utilized in a sensing measurement), a maximum time duration that the radio node may store the obtained measurement data, a minimum time from reception and/or transmission of a sensing signal that an indicated measurement report can be transmitted by the radio node, and the like. In such embodiments, the configuration of sensing measurements may be based, at least in part, on the capability information.

In some embodiments, the frequency shift/doppler shift of a respective propagation path may include the frequency difference between a sensing signal received via the propagation path and an expected frequency of the received sensing signal when no moving object or Tx/Rx entity is present in the propagation environment of the path.

In some embodiments, the frequency difference of two signals may be a frequency shift value that, when applied on the first signal, generates a shifted signal that is closest (among different frequency shift values) to the second signal, according to a distance measure of signals, e.g., norm-2 of the signal difference.

In some implementations, the processor 802 and the memory 804 coupled with the processor 802 may be configured to cause the UE 800 to perform one or more of the SensMF functions described herein (e.g., executing, by the processor 802, instructions stored in the memory 804). For example, the processor 802 may support wireless communication at the UE 800 in accordance with examples as disclosed herein. The UE 800 may be configured to support a means for determining a set of radio nodes for performing a sensing procedure, the set of radio nodes including a set of transmitting nodes and a set of receiving nodes and to support a means for transmitting, to the set of transmitting nodes, a signaling configuration for performing a sensing signal transmission.

In some embodiments, the UE 800 is configured to support a means for transmitting, to the set of receiving nodes, a sensing configuration for performing a sensing signal measurement and reporting, where the sensing configuration includes an indication of a first propagation path (i.e., p₁) and an indication of a second propagation path (i.e., p₂), where the first propagation path is associated with a sensing target.

In some embodiments, the UE 800 is configured to support a means for receiving a sensing measurement report including a differential sensing measurement (i.e., ΔV) based on the first sensing measurement and the second sensing measurement, where the differential sensing measurement indicates a difference in measured values associated with the first propagation path and the second propagation path, e.g., ΔV=V(p₁)−V(p₂), where V(p₁) and V(p₂) are values of the path measurements conducted of paths p₁ and p₂, respectively. In some embodiments, the UE 800 is configured to support a means for determining sensing information based at least in part on differential sensing measurement.

In certain implementations, the sensing configuration indicates one or more of: A) a time/frequency resource for transmitting the report; B) a condition for transmitting the report; C) a measurement type of the first sensing measurement; D) a measurement type of the second sensing measurement; or E) a combination thereof.

In certain implementations, the second propagation path is associated with a LoS path between a receiving node radio and a transmitting node or with a reflection path between the receiving node and a known reflector.

In certain implementations, the differential sensing measurement is based on at least one of: A) a DL RSTD of the first propagation path and the second propagation path; B) a DL RSDD of the first propagation path and the second propagation path; C) a DL RSAD of the first propagation path and the second propagation path; or D) a combination thereof.

In certain implementations, the differential sensing measurement is based on at least one of: A) a SL RSTD of the first propagation path and the second propagation path; B) a SL RSDD of the first propagation path and the second propagation path; C) a SL RSAD of the first propagation path and the second propagation path; or D) a combination thereof.

In certain implementations, the first propagation path is associated with a UL direction or a UL subframe or a first inter-RAN direction, where the second propagation path is associated with the UL direction or the UL subframe or a second inter-RAN direction, and where the differential sensing measurement is based on at least one of: A) a RSTD of the first propagation path and the second propagation path; B) a RSDD of the first propagation path and the second propagation path; C) a RSAD of the first propagation path and the second propagation path; or D) a combination thereof.

In certain implementations, the first propagation path is associated with a SL direction or a SL subframe, where the second propagation path is associated with a DL direction or a DL subframe, and where the differential sensing measurement is based on at least one of: A) a XL RSTD of the first propagation path and the second propagation path; B) a XL RSDD of the first propagation path and the second propagation path; C) a XL RSAD of the first propagation path and the second propagation path; or D) a combination thereof.

In certain implementations, the sensing measurement report further indicates an association of the first propagation path or the second propagation path to one or more of: A) a previously indicated sensing target; B) a path group, where the first propagation path or the second propagation path is a member of the path group; C) a previously reported propagation path; or D) a combination thereof.

In certain implementations, the sensing measurement report further indicates a path condition including one or more of: A) a stability condition of the first propagation path or the second propagation path; B) a LoS condition the second propagation path; C) a NLoS condition of the first propagation path or the second propagation path; or D) a combination thereof.

In some embodiments, the UE 800 (e.g., acting as the SensMF) may be configured to receive information regarding a radio node's capability for sensing measurements. A radio node's capability information may include, but is not limited to, a type of the supported measurement, a supported time of measurements and/or reporting (e.g., the maximum supported duration of a sensing signal which can be utilized in a sensing measurement), a maximum time duration that the radio node may store the obtained measurement data, a minimum time from reception and/or transmission of a sensing signal that an indicated measurement report can be transmitted by the radio node, and the like. In such embodiments, the UE 800 may be further configured to determine the configuration of sensing measurement(s) and/or radio node(s) based, at least in part, on the capability information.

In some embodiments, the frequency shift/doppler shift of a respective propagation path may include the frequency difference between a sensing signal received via the propagation path and an expected frequency of the received sensing signal when no moving object or Tx/Rx entity is present in the propagation environment of the path.

In some embodiments, the frequency difference of two signals may be a frequency shift value that, when applied on the first signal, generates a shifted signal that is closest (among different frequency shift values) to the second signal, according to a distance measure of signals, e.g., norm-2 of the signal difference.

The controller 806 may manage input and output signals for the UE 800. The controller 806 may also manage peripherals not integrated into the UE 800. In some implementations, the controller 806 may utilize an operating system (OS) such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding/processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

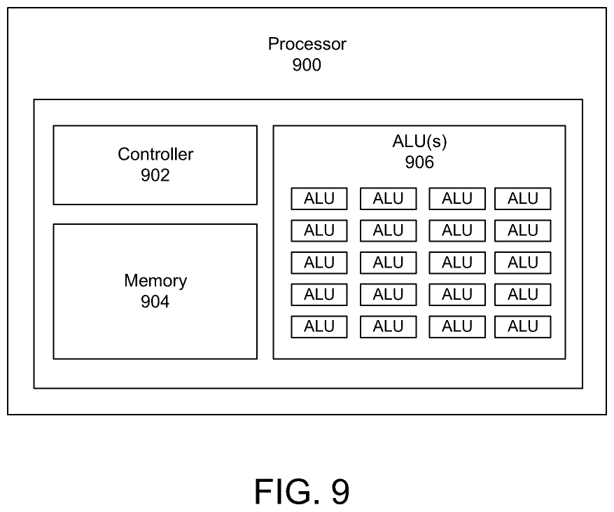

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

In various embodiments, the processor 900 may support wireless communication of a sensing radio node, such as a UE or gNB, in accordance with examples as disclosed herein. For example, the processor 900 may be configured to support a means for receiving a sensing configuration for sensing signal measurement and reporting, where the sensing configuration includes an indication of a first propagation path (i.e., p₁) and an indication of a second propagation path (i.e., p₂), where the first propagation path is associated with a sensing target (e.g., an object of interest or an area of interest).

In some embodiments, the processor 900 is configured to support a means for performing a first sensing measurement of the first propagation path in accordance with the sensing configuration.

In some embodiments, the processor 900 is configured to support a means for performing a second sensing measurement of the second propagation path in accordance with the sensing configuration.

In some embodiments, the processor 900 is configured to support a means for transmitting a sensing measurement report including a differential sensing measurement (i.e., ΔV) based on the first sensing measurement and the second sensing measurement, where the differential sensing measurement indicates a difference in measured values associated with the first propagation path and the second propagation path, e.g., ΔV=V(p₁)−V(p₂), where V(p₁) and V(p₂) are values of the path measurements conducted of paths p₁ and p₂, respectively.

In certain implementations, the sensing configuration indicates one or more of: A) a time/frequency resource for transmitting the report; B) a condition for transmitting the report; C) a measurement type of the first sensing measurement; D) a measurement type of the second sensing measurement; or E) a combination thereof.

In certain implementations, the second propagation path is associated with a LoS path between the radio node including the processor 900 and a sensing Tx node (i.e., sensing signal transmitter). In one embodiment, the second propagation path may include a re-transmission, e.g., from a NCR, an IAB node, etc. In certain implementations, the second propagation path is associated with a reflection path between the radio node including the processor 900 and a known reflector. For example, the known reflector may be a metallic object (e.g., vehicle) with a known position and/or known reflection characteristics.

In certain implementations, the processor 900 is further configured to identify the first propagation path or the second propagation path based on one or more of: A) one or more propagation time/delay characteristics; B) a propagation path directional information; C) a pattern of movement associated with the first propagation path or the second propagation path; D) a power level associated with the first propagation path or the second propagation path; E) a path group, where the first propagation path or the second propagation path is a member of the path group; F) a relative description of an identified propagation path or a known propagation path; or G) a combination thereof. Note here that the path group may be defined with a certain value range of azimuth, zenith, doppler, delay (or a combination thereof).

In certain implementations, the first sensing measurement and the second sensing measurement are further associated with one or more of: A) a same measurement time; B) a same measurement type; C) a same sensing signal; D) a same sensing transmitter (i.e., same sensing Tx node); or E) a combination thereof. In certain implementations, the first sensing measurement and the second sensing measurement are further associated with one or more of: A) a different measurement time; B) a different measurement type; C) a different sensing signal; D) a different sensing transmitter (i.e., different sensing Tx node); or E) a combination thereof.

In certain implementations, the differential sensing measurement is based on at least one of: A) a DL RSTD of the first propagation path and the second propagation path; B) a DL RSDD of the first propagation path and the second propagation path; C) a DL RSAD of the first propagation path and the second propagation path; or D) a combination thereof.

In certain implementations, the differential sensing measurement is based on at least one of: A) a SL RSTD of the first propagation path and the second propagation path; B) a SL RSDD of the first propagation path and the second propagation path; C) a SL RSAD of the first propagation path and the second propagation path; or D) a combination thereof.

In certain implementations, the first propagation path is associated with a UL direction or a UL subframe or a first inter-RAN direction, where the second propagation path is associated with the UL direction or the UL subframe or a second inter-RAN direction, and where the differential sensing measurement is based on at least one of: A) a RSTD of the first propagation path and the second propagation path; B) a RSDD of the first propagation path and the second propagation path; C) a RSAD of the first propagation path and the second propagation path; or D) a combination thereof.

In certain implementations, the first propagation path is associated with a SL direction or a SL subframe, where the second propagation path is associated with a DL direction or a DL subframe, and where the differential sensing measurement is based on at least one of: A) a XL RSTD of the first propagation path and the second propagation path; B) a XL RSDD of the first propagation path and the second propagation path; C) a XL RSAD of the first propagation path and the second propagation path; or D) a combination thereof.

In certain implementations, the sensing measurement report further indicates an association of the first propagation path or the second propagation path to one or more of: A) a previously indicated sensing target (e.g., reporting of a path is associated with a sensing target indicated to the measurement node); B) a path group, where the first propagation path or the second propagation path is a member of the path group; C) a previously reported propagation path (e.g., an indication that the reported path is the same as or continuation of a previously reported or indicated path, which may hold a different/updated value, such as an updated angle of a reflection path from a moving target object); or D) a combination thereof.

In certain implementations, the sensing measurement report further indicates a path condition including one or more of: A) a stability condition of the first propagation path or the second propagation path (e.g., not changing in delay, angle, doppler shift, RSRPP, or a combination thereof, potentially based on an indicated criteria (e.g., threshold for change) and type of the change (e.g., perceived path delay)); B) a LoS condition the second propagation path; C) a NLoS condition of the first propagation path or the second propagation path; or D) a combination thereof. In further implementations, the processor 900 is further configured to indicate the path condition using an index of a codebook, where the codebook includes a set of predetermined path conditions.

In certain implementations, the processor 900 is further configured to receive a set of candidate paths and select the second propagation path from the set of candidate paths, where the second propagation path is a reference path for the sensing signal measurement and reporting. Here, each candidate path is associated with a respective transmitter (i.e., sensing Tx node) or sensing signal, or both. In further implementations, the processor 900 is further configured to receive one or more criteria for the selection of the second propagation path.

In some embodiments, the processor 900 (e.g., acting as a sensing measurement node) may be configured to transmit information regarding its capability for sensing measurements to the SensMF. The capability information may include, but is not limited to, a type of the supported measurement, a supported time of measurements and/or reporting (e.g., the maximum supported duration of a sensing signal which can be utilized in a sensing measurement), a maximum time duration that the radio node may store the obtained measurement data, a minimum time from reception and/or transmission of a sensing signal that an indicated measurement report can be transmitted by the radio node, and the like. In such embodiments, the configuration of sensing measurements may be based, at least in part, on the capability information.

In some embodiments, the frequency shift/doppler shift of a respective propagation path may include the frequency difference between a sensing signal received via the propagation path and an expected frequency of the received sensing signal when no moving object or Tx/Rx entity is present in the propagation environment of the path.

In some embodiments, the frequency difference of two signals may be a frequency shift value that, when applied on the first signal, generates a shifted signal that is closest (among different frequency shift values) to the second signal, according to a distance measure of signals, e.g., norm-2 of the signal difference.

In various embodiments, the processor 900 may support wireless communication of a SensMF, in accordance with examples as disclosed herein. For example, the processor 900 may be configured to support a means for determining a set of radio nodes for performing a sensing procedure, the set of radio nodes including a set of transmitting nodes and a set of receiving nodes and to support a means for transmitting, to the set of transmitting nodes, a signaling configuration for performing a sensing signal transmission.

In some embodiments, the processor 900 is configured to support a means for transmitting, to the set of receiving nodes, a sensing configuration for performing a sensing signal measurement and reporting, where the sensing configuration includes an indication of a first propagation path (i.e., p₁) and an indication of a second propagation path (i.e., p₂), where the first propagation path is associated with a sensing target.

In some embodiments, the processor 900 is configured to support a means for receiving a sensing measurement report including a differential sensing measurement (i.e., ΔV) based on the first sensing measurement and the second sensing measurement, where the differential sensing measurement indicates a difference in measured values associated with the first propagation path and the second propagation path, e.g., ΔV=V(p₁)−V(p₂), where V(p₁) and V(p₂) are values of the path measurements conducted of paths p₁ and p₂, respectively. In some embodiments, the processor 900 is configured to support a means for determining sensing information based at least in part on differential sensing measurement.

In certain implementations, the sensing configuration indicates one or more of: A) a time/frequency resource for transmitting the report; B) a condition for transmitting the report; C) a measurement type of the first sensing measurement; D) a measurement type of the second sensing measurement; or E) a combination thereof.

In certain implementations, the second propagation path is associated with a LoS path between a receiving node radio and a transmitting node or with a reflection path between the receiving node and a known reflector.

In certain implementations, the differential sensing measurement is based on at least one of: A) a DL RSTD of the first propagation path and the second propagation path; B) a DL RSDD of the first propagation path and the second propagation path; C) a DL RSAD of the first propagation path and the second propagation path; or D) a combination thereof.

In certain implementations, the differential sensing measurement is based on at least one of: A) a SL RSTD of the first propagation path and the second propagation path; B) a SL RSDD of the first propagation path and the second propagation path; C) a SL RSAD of the first propagation path and the second propagation path; or D) a combination thereof.

In certain implementations, the first propagation path is associated with a UL direction or a UL subframe or a first inter-RAN direction, where the second propagation path is associated with the UL direction or the UL subframe or a second inter-RAN direction, and where the differential sensing measurement is based on at least one of: A) a RSTD of the first propagation path and the second propagation path; B) a RSDD of the first propagation path and the second propagation path; C) a RSAD of the first propagation path and the second propagation path; or D) a combination thereof.

In certain implementations, the first propagation path is associated with a SL direction or a SL subframe, where the second propagation path is associated with a DL direction or a DL subframe, and where the differential sensing measurement is based on at least one of: A) a XL RSTD of the first propagation path and the second propagation path; B) a XL RSDD of the first propagation path and the second propagation path; C) a XL RSAD of the first propagation path and the second propagation path; or D) a combination thereof.

In certain implementations, the sensing measurement report further indicates an association of the first propagation path or the second propagation path to one or more of: A) a previously indicated sensing target; B) a path group, where the first propagation path or the second propagation path is a member of the path group; C) a previously reported propagation path; or D) a combination thereof.

In certain implementations, the sensing measurement report further indicates a path condition including one or more of: A) a stability condition of the first propagation path or the second propagation path; B) a LoS condition the second propagation path; C) a NLoS condition of the first propagation path or the second propagation path; or D) a combination thereof.

In some embodiments, the processor 900 (e.g., acting as the SensMF) may be configured to receive information regarding a radio node's capability for sensing measurements. A radio node's capability information may include, but is not limited to, a type of the supported measurement, a supported time of measurements and/or reporting (e.g., the maximum supported duration of a sensing signal which can be utilized in a sensing measurement), a maximum time duration that the radio node may store the obtained measurement data, a minimum time from reception and/or transmission of a sensing signal that an indicated measurement report can be transmitted by the radio node, and the like. In such embodiments, the processor 900 may be further configured to determine the configuration of sensing measurement(s) and/or radio node(s) based, at least in part, on the capability information.

In some embodiments, the frequency shift/doppler shift of a respective propagation path may include the frequency difference between a sensing signal received via the propagation path and an expected frequency of the received sensing signal when no moving object or Tx/Rx entity is present in the propagation environment of the path.

In some embodiments, the frequency difference of two signals may be a frequency shift value that, when applied on the first signal, generates a shifted signal that is closest (among different frequency shift values) to the second signal, according to a distance measure of signals, e.g., norm-2 of the signal difference.

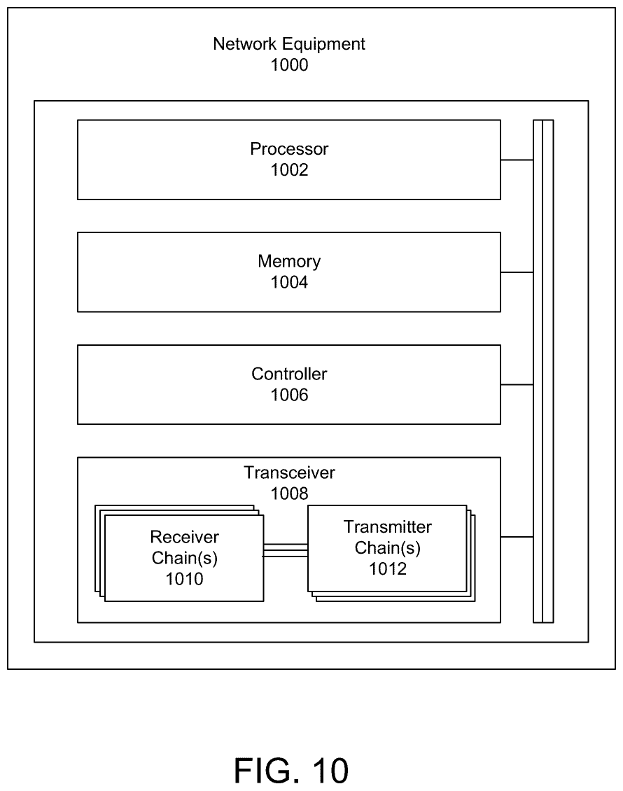

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the SensMF behaviors described herein (e.g., executing, by the processor 1002, instructions stored in the memory 1004). For example, the processor 1002 may support wireless communication at the NE 1000 in accordance with examples as disclosed herein. The NE 1000 may be configured to support a means for determining a set of radio nodes for performing a sensing procedure, the set of radio nodes including a set of transmitting nodes and a set of receiving nodes and to support a means for transmitting, to the set of transmitting nodes, a signaling configuration for performing a sensing signal transmission.

In some embodiments, the processor 900 is configured to support a means for transmitting, to the set of receiving nodes, a sensing configuration for performing a sensing signal measurement and reporting, where the sensing configuration includes an indication of a first propagation path (i.e., p₁) and an indication of a second propagation path (i.e., p₂), where the first propagation path is associated with a sensing target.

In some embodiments, the processor 900 is configured to support a means for receiving a sensing measurement report including a differential sensing measurement (i.e., ΔV) based on the first sensing measurement and the second sensing measurement, where the differential sensing measurement indicates a difference in measured values associated with the first propagation path and the second propagation path, e.g., ΔV=V(p₁)−V(p₂), where V(p₁) and V(p₂) are values of the path measurements conducted of paths p₁ and p₂, respectively. In some embodiments, the processor 900 is configured to support a means for determining sensing information based at least in part on differential sensing measurement.

In certain implementations, the sensing configuration indicates one or more of: A) a time/frequency resource for transmitting the report; B) a condition for transmitting the report; C) a measurement type of the first sensing measurement; D) a measurement type of the second sensing measurement; or E) a combination thereof.

In certain implementations, the second propagation path is associated with a LoS path between a receiving node radio and a transmitting node or with a reflection path between the receiving node and a known reflector.

In certain implementations, the differential sensing measurement is based on at least one of: A) a DL RSTD of the first propagation path and the second propagation path; B) a DL RSDD of the first propagation path and the second propagation path; C) a DL RSAD of the first propagation path and the second propagation path; or D) a combination thereof.

In certain implementations, the differential sensing measurement is based on at least one of: A) a SL RSTD of the first propagation path and the second propagation path; B) a SL RSDD of the first propagation path and the second propagation path; C) a SL RSAD of the first propagation path and the second propagation path; or D) a combination thereof.

In certain implementations, the first propagation path is associated with a UL direction or a UL subframe or a first inter-RAN direction, where the second propagation path is associated with the UL direction or the UL subframe or a second inter-RAN direction, and where the differential sensing measurement is based on at least one of: A) a RSTD of the first propagation path and the second propagation path; B) a RSDD of the first propagation path and the second propagation path; C) a RSAD of the first propagation path and the second propagation path; or D) a combination thereof.

In certain implementations, the first propagation path is associated with a SL direction or a SL subframe, where the second propagation path is associated with a DL direction or a DL subframe, and where the differential sensing measurement is based on at least one of: A) a XL RSTD of the first propagation path and the second propagation path; B) a XL RSDD of the first propagation path and the second propagation path; C) a XL RSAD of the first propagation path and the second propagation path; or D) a combination thereof.

In certain implementations, the sensing measurement report further indicates an association of the first propagation path or the second propagation path to one or more of: A) a previously indicated sensing target; B) a path group, where the first propagation path or the second propagation path is a member of the path group; C) a previously reported propagation path; or D) a combination thereof.

In certain implementations, the sensing measurement report further indicates a path condition including one or more of: A) a stability condition of the first propagation path or the second propagation path; B) a LoS condition the second propagation path; C) a NLoS condition of the first propagation path or the second propagation path; or D) a combination thereof.

In some embodiments, the NE 1000 (e.g., acting as the as SensMF) may be configured to receive information regarding a radio node's capability for sensing measurements. A radio node's capability information may include, but is not limited to, a type of the supported measurement, a supported time of measurements and/or reporting (e.g., the maximum supported duration of a sensing signal which can be utilized in a sensing measurement), a maximum time duration that the radio node may store the obtained measurement data, a minimum time from reception and/or transmission of a sensing signal that an indicated measurement report can be transmitted by the radio node, and the like. In such embodiments, the NE 1000 may be further configured to determine the configuration of sensing measurement(s) and/or radio node(s) based, at least in part, on the capability information.

In some embodiments, the frequency shift/doppler shift of a respective propagation path may include the frequency difference between a sensing signal received via the propagation path and an expected frequency of the received sensing signal when no moving object or Tx/Rx entity is present in the propagation environment of the path.

In some embodiments, the frequency difference of two signals may be a frequency shift value that, when applied on the first signal, generates a shifted signal that is closest (among different frequency shift values) to the second signal, according to a distance measure of signals, e.g., norm-2 of the signal difference.

In some implementations, the processor 1002 and the memory 1004 coupled with the processor 1002 may be configured to cause the NE 1000 to perform one or more of the measurement node and/or radio sensing node functions described herein (e.g., executing, by the processor 1002, instructions stored in the memory 1004). For example, the processor 1002 may support wireless communication at the NE 1000 in accordance with examples as disclosed herein. The NE 1000 may be configured to support a means for receiving a sensing configuration for sensing signal measurement and reporting, where the sensing configuration includes an indication of a first propagation path (i.e., p₁) and an indication of a second propagation path (i.e., p₂), where the first propagation path is associated with a sensing target (e.g., an object of interest or an area of interest).

In some embodiments, the NE 1000 is configured to support a means for performing a first sensing measurement of the first propagation path in accordance with the sensing configuration. In some embodiments, the NE 1000 is configured to support a means for performing a second sensing measurement of the second propagation path in accordance with the sensing configuration.

In some embodiments, the NE 1000 is configured to support a means for transmitting a sensing measurement report including a differential sensing measurement (i.e., ΔV) based on the first sensing measurement and the second sensing measurement, where the differential sensing measurement indicates a difference in measured values associated with the first propagation path and the second propagation path, e.g., ΔV=V(p₁)−V(p₂), where V(p₁) and V(p₂) are values of the path measurements conducted of paths p₁ and p₂, respectively.

In certain implementations, the sensing configuration indicates one or more of: A) a time/frequency resource for transmitting the report; B) a condition for transmitting the report; C) a measurement type of the first sensing measurement; D) a measurement type of the second sensing measurement; or E) a combination thereof.

In certain implementations, the second propagation path is associated with a LoS path between the NE 1000 and a sensing Tx node (i.e., sensing signal transmitter). In one embodiment, the second propagation path may include a re-transmission, e.g., from a NCR, an IAB node, etc. In certain implementations, the second propagation path is associated with a reflection path between the radio node including the NE 1000 and a known reflector.

In certain implementations, the NE 1000 is further configured to identify the first propagation path or the second propagation path based on one or more of: A) one or more propagation time/delay characteristics; B) a propagation path directional information; C) a pattern of movement associated with the first propagation path or the second propagation path; D) a power level associated with the first propagation path or the second propagation path; E) a path group, where the first propagation path or the second propagation path is a member of the path group; F) a relative description of an identified propagation path or a known propagation path; or G) a combination thereof. Note here that the path group may be defined with a certain value range of azimuth, zenith, doppler, delay (or a combination thereof).

In certain implementations, the first sensing measurement and the second sensing measurement are further associated with one or more of: A) a same measurement time; B) a same measurement type; C) a same sensing signal; D) a same sensing transmitter (i.e., same sensing Tx node); or E) a combination thereof. In certain implementations, the first sensing measurement and the second sensing measurement are further associated with one or more of: A) a different measurement time; B) a different measurement type; C) a different sensing signal; D) a different sensing transmitter (i.e., different sensing Tx node); or E) a combination thereof.

In certain implementations, the differential sensing measurement is based on at least one of: A) a DL RSTD of the first propagation path and the second propagation path; B) a DL RSDD of the first propagation path and the second propagation path; C) a DL RSAD of the first propagation path and the second propagation path; or D) a combination thereof.

In certain implementations, the differential sensing measurement is based on at least one of: A) a UL RSTD of the first propagation path and the second propagation path; B) a UL RSDD of the first propagation path and the second propagation path; C) a UL RSAD of the first propagation path and the second propagation path; or D) a combination thereof.

In certain implementations, the first propagation path is associated with a UL direction or a UL subframe or a first inter-RAN direction, where the second propagation path is associated with the UL direction or the UL subframe or a second inter-RAN direction, and where the differential sensing measurement is based on at least one of: A) a RSTD of the first propagation path and the second propagation path; B) a RSDD of the first propagation path and the second propagation path; C) a RSAD of the first propagation path and the second propagation path; or D) a combination thereof.

In certain implementations, the sensing measurement report further indicates an association of the first propagation path or the second propagation path to one or more of: A) a previously indicated sensing target (e.g., reporting of a path is associated with a sensing target indicated to the measurement node); B) a path group, where the first propagation path or the second propagation path is a member of the path group; C) a previously reported propagation path (e.g., an indication that the reported path is the same as or continuation of a previously reported or indicated path, which may hold a different/updated value, such as an updated angle of a reflection path from a moving target object); or D) a combination thereof.

In certain implementations, the sensing measurement report further indicates a path condition including one or more of: A) a stability condition of the first propagation path or the second propagation path (e.g., not changing in delay, angle, doppler shift, RSRPP, or a combination thereof, potentially based on an indicated criteria (e.g., threshold for change) and type of the change (e.g., perceived path delay)); B) a LoS condition the second propagation path; C) a NLoS condition of the first propagation path or the second propagation path; or D) a combination thereof. In further implementations, the NE 1000 is further configured to indicate the path condition using an index of a codebook, where the codebook includes a set of predetermined path conditions.

In certain implementations, the NE 1000 is further configured to receive a set of candidate paths and select the second propagation path from the set of candidate paths, where the second propagation path is a reference path for the sensing signal measurement and reporting. Here, each candidate path is associated with a respective transmitter (i.e., sensing Tx node) or sensing signal, or both. In further implementations, the NE 1000 is further configured to receive one or more criteria for the selection of the second propagation path.

In some embodiments, the NE 1000 (e.g., acting as a sensing measurement node) may be configured to transmit information regarding its capability for sensing measurements to the SensMF. The capability information may include, but is not limited to, a type of the supported measurement, a supported time of measurements and/or reporting (e.g., the maximum supported duration of a sensing signal which can be utilized in a sensing measurement), a maximum time duration that the radio node may store the obtained measurement data, a minimum time from reception and/or transmission of a sensing signal that an indicated measurement report can be transmitted by the radio node, and the like. In such embodiments, the configuration of sensing measurements may be based, at least in part, on the capability information.

In some embodiments, the frequency shift/doppler shift of a respective propagation path may include the frequency difference between a sensing signal received via the propagation path and an expected frequency of the received sensing signal when no moving object or Tx/Rx entity is present in the propagation environment of the path.

In some embodiments, the frequency difference of two signals may be a frequency shift value that, when applied on the first signal, generates a shifted signal that is closest (among different frequency shift values) to the second signal, according to a distance measure of signals, e.g., norm-2 of the signal difference.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding/processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

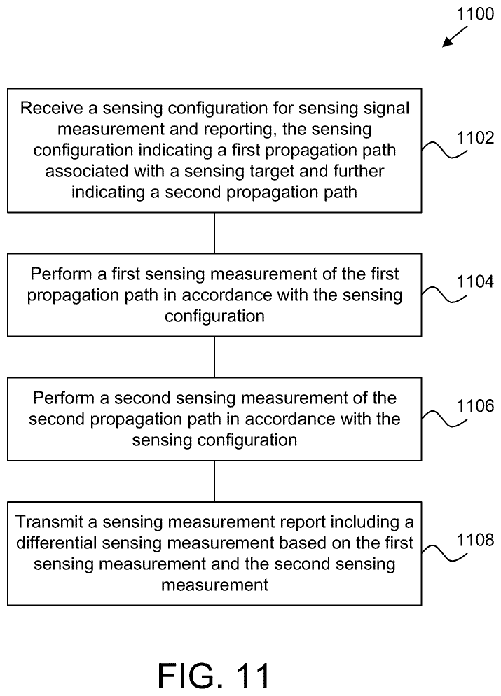

FIG. 11 depicts one embodiment of a method 1100 in accordance with aspects of the present disclosure. In various embodiments, the operations of the method 1100 may be implemented by a measurement node, as described herein. As described, the measurement node is a radio node participating in a radio sensing task and may be a UE or a gNB/TRP. In some implementations, the radio node may execute a set of instructions to control the function elements of the radio node to perform the described functions.

At step 1102, the method 1100 may include receiving a sensing configuration for sensing signal measurement and reporting, the sensing configuration indicating a first propagation path associated with a sensing target and further indicating a second propagation path. The operations of step 1102 may be performed in accordance with examples as described herein. In some implementations, aspects of the operation of step 1102 may be performed by a UE, as described with reference to FIG. 8, or by a NE, as described with reference to FIG. 10.

At step 1104, the method 1100 may include performing a first sensing measurement of the first propagation path in accordance with the sensing configuration. The operations of step 1104 may be performed in accordance with examples as described herein. In some implementations, aspects of the operation of step 1104 may be performed by a UE, as described with reference to FIG. 8, or by a NE, as described with reference to FIG. 10.

At step 1106, the method 1100 may include performing a second sensing measurement of the second propagation path in accordance with the sensing configuration. The operations of step 1106 may be performed in accordance with examples as described herein. In some implementations, aspects of the operation of step 1106 may be performed by a UE, as described with reference to FIG. 8, or by a NE, as described with reference to FIG. 10.

At step 1108, the method 1100 may include transmitting a sensing measurement report including a differential sensing measurement based on the first sensing measurement and the second sensing measurement, where the differential sensing measurement indicates a difference in measured values associated with the first propagation path and the second propagation path. The operations of step 1108 may be performed in accordance with examples as described herein. In some implementations, aspects of the operation of step 1106 may be performed by a UE, as described with reference to FIG. 8, or by a NE, as described with reference to FIG. 10.

It should be noted that the method 1100 described herein describes one possible implementation, and that the operations and the steps may be rearranged or otherwise modified and that other implementations are possible.

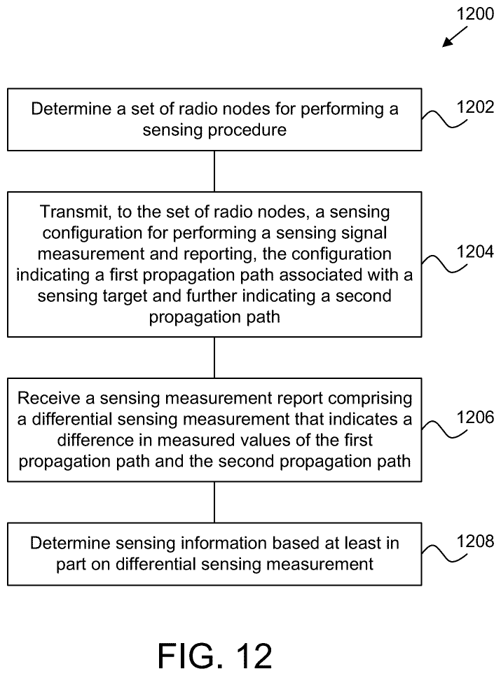

FIG. 12 depicts one embodiment of a method 1200 in accordance with aspects of the present disclosure. The operations of the method 1200 may be implemented by a SensMF as described herein. As described above, the SensMF may be a UE, a gNB/RAN node, an SF, or a combination thereof. In some implementations, the SensMF may execute a set of instructions to control the function elements of the SensMF to perform the described functions.

At step 1202, the method 1200 may include determining a set of radio nodes for performing a sensing procedure, the set of radio nodes comprising a set of receiving nodes. The operations of step 1202 may be performed in accordance with examples as described herein. In some implementations, aspects of the operations of step 1202 may be performed by a UE, as described with reference to FIG. 8, or by a NE, as described with reference to FIG. 10.

At step 1204, the method 1200 may include transmitting, to the set of receiving nodes, a sensing configuration for performing sensing signal measurement and reporting, the sensing configuration indicating a first propagation path associated with a sensing target and further indicating a second propagation path. The operations of step 1204 may be performed in accordance with examples as described herein. In some implementations, aspects of the operations of step 1204 may be performed by a UE, as described with reference to FIG. 8, or by a NE, as described with reference to FIG. 10.

At step 1206, the method 1200 may include receiving a sensing measurement report comprising a differential sensing measurement that indicates a difference in measured values of the first propagation path and the second propagation path. The operations of step 1206 may be performed in accordance with examples as described herein. In some implementations, aspects of the operations of step 1206 may be performed by a UE, as described with reference to FIG. 8, or by a NE, as described with reference to FIG. 10.

At step 1208, the method 1200 may include determining sensing information based at least in part on differential sensing measurement. The operations of step 1208 may be performed in accordance with examples as described herein. In some implementations, aspects of the operations of step 1208 may be performed by a UE, as described with reference to FIG. 8, or by a NE, as described with reference to FIG. 10.

It should be noted that the method 1200 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a sensing configuration for sensing signal measurement and reporting, wherein the sensing configuration comprises an indication of a first propagation path and an indication of a second propagation path, and wherein the first propagation path is associated with a sensing target;
perform a first sensing measurement of the first propagation path in accordance with the sensing configuration;
perform a second sensing measurement of the second propagation path in accordance with the sensing configuration; and
transmit a sensing measurement report comprising a differential sensing measurement based on the first sensing measurement and the second sensing measurement, wherein the differential sensing measurement indicates a difference in measured values associated with the first propagation path and the second propagation path.

2. The UE of claim 1, wherein the sensing configuration indicates one or more of:
a time/frequency resource for transmitting the report;
a condition for transmitting the report;
a first measurement type of the first sensing measurement;
a second measurement type of the second sensing measurement;
or a combination thereof.

3. The UE of claim 1, wherein the second propagation path is associated with a line-of-sight (LoS) path between the UE and a transmitter or with a reflection path between the UE and a known reflector.

4. The UE of claim 1, wherein the at least one processor is configured to cause the UE to identify the first propagation path or the second propagation path based on one or more of:
one or more propagation time/delay characteristics;
a propagation path directional information;
a pattern of movement associated with the first propagation path or the second propagation path;
a power level associated with the first propagation path or the second propagation path;
a path group, wherein the first propagation path or the second propagation path is a member of the path group;
a relative description of an identified propagation path or a known propagation path;
or a combination thereof.

5. The UE of claim 1, wherein the first sensing measurement and the second sensing measurement are further associated with one or more of:
a same measurement time;
a same measurement type;
a same sensing signal;
a same sensing transmitter of the sensing signal;
or a combination thereof.

6. The UE of claim 1, wherein the first sensing measurement and the second sensing measurement are further associated with one or more of:
a different measurement time;
a different measurement type;
a different sensing signal;
a different sensing transmitter of the sensing signal;
or a combination thereof.

7. The UE of claim 1, wherein the differential sensing measurement is based on at least one of:
a downlink (DL) reference signal time difference (RSTD) of the first propagation path and the second propagation path;
a DL reference signal doppler difference (RSDD) of the first propagation path and the second propagation path; or
a DL reference signal angular difference (RSAD) of the first propagation path and the second propagation path.

8. The UE of claim 1, wherein the differential sensing measurement is based on at least one of:
a sidelink (SL) reference signal time difference (RSTD) of the first propagation path and the second propagation path;
a SL reference signal doppler difference (RSDD) of the first propagation path and the second propagation path; or
a SL reference signal angular difference (RSAD) of the first propagation path and the second propagation path;
a reference signal doppler difference (RSDD) of the first propagation path and the second propagation path; or
a reference signal angular difference (RSAD) of the first propagation path and the second propagation path.

9. The UE of claim 1, wherein the first propagation path is associated with a sidelink (SL) direction or a SL subframe, wherein the second propagation path is associated with a downlink (DL) direction or a DL subframe, and wherein the differential sensing measurement is based on at least one of:
a sidelink-and-downlink (XL) reference signal time difference (RSTD) of the first propagation path and the second propagation path;
a XL reference signal doppler difference (RSDD) of the first propagation path and the second propagation path; or
a XL reference signal angular difference (RSAD) of the first propagation path and the second propagation path.

10. The UE of claim 1, wherein the sensing measurement report further indicates an association of the first propagation path or the second propagation path to one or more of:
a previously indicated sensing target;
a path group, wherein the first propagation path or the second propagation path is a member of the path group;
a previously reported propagation path;
or a combination thereof.

11. The UE of claim 1, wherein the sensing measurement report further indicates a path condition comprising one or more of:
a stability condition of the first propagation path or the second propagation path;
a line-of-sight (LoS) condition the second propagation path;
a non-line-of-sight (NloS) condition of the first propagation path or the second propagation path;
or a combination thereof.

12. The UE of claim 11, wherein the at least one processor is configured to cause the UE to indicate the path condition using an index of a codebook, wherein the codebook comprises a set of predetermined path conditions.

13. The UE of claim 1, wherein the at least one processor is configured to cause the UE to:
receive a set of candidate paths, each candidate path is associated with a respective transmitter or sensing signal, or both; and
select the second propagation path from the set of candidate paths, wherein the second propagation path is a reference path for the sensing signal measurement and reporting.

14. The UE of claim 13, wherein the at least one processor is configured to cause the UE to receive one or more criteria for the selection of the second propagation path.

15. A processor for wireless communication, comprising:
at least one controller coupled with at least one memory and configured to cause the processor to:
receive a sensing configuration for sensing signal measurement and reporting, wherein the sensing configuration comprises an indication of a first propagation path and an indication of a second propagation path, and wherein the first propagation path is associated with a sensing target;
perform a first sensing measurement of the first propagation path in accordance with the sensing configuration;
perform a second sensing measurement of the second propagation path in accordance with the sensing configuration; and
transmit a sensing measurement report comprising a differential sensing measurement based on the first sensing measurement and the second sensing measurement, wherein the differential sensing measurement indicates a difference in measured values associated with the first propagation path and the second propagation path.

16. A base station for wireless communication, comprising:
at least one memory; and
at least one processor coupled with the at least one memory and configured to cause the base station to:
determine a set of radio nodes for performing a sensing procedure;
transmit, to the set of radio nodes, a sensing configuration for performing a sensing signal measurement and reporting, wherein the sensing configuration comprises an indication of a first propagation path and an indication of a second propagation path, and wherein the first propagation path is associated with a sensing target;
receive a sensing measurement report comprising a differential sensing measurement, wherein the differential sensing measurement indicates a difference in measured values associated with the first propagation path and the second propagation path; and
determine sensing information based at least in part on differential sensing measurement.

17. The base station of claim 16, wherein the sensing configuration indicates one or more of:
a time/frequency resource for transmitting the report;
a condition for transmitting the report;
a measurement type of the first sensing measurement;
a measurement type of the second sensing measurement;
or a combination thereof.

18. The base station of claim 16, wherein the differential sensing measurement is based on at least one of:
a downlink (DL) reference signal time difference (RSTD) of the first propagation path and the second propagation path;
a DL reference signal doppler difference (RSDD) of the first propagation path and the second propagation path; or
a DL reference signal angular difference (RSAD) of the first propagation path and the second propagation path.

19. The base station of claim 16, wherein the differential sensing measurement is based on at least one of:
a sidelink (SL) reference signal time difference (RSTD) of the first propagation path and the second propagation path;
a SL reference signal doppler difference (RSDD) of the first propagation path and the second propagation path; or
a SL reference signal angular difference (RSAD) of the first propagation path and the second propagation path.

20. A method performed by a sensing measurement controller, the method comprising:
determining a set of radio nodes for performing a sensing procedure;
transmitting, to the set of radio nodes, a sensing configuration for performing a sensing signal measurement and reporting, wherein the sensing configuration comprises an indication of a first propagation path and an indication of a second propagation path, and wherein the first propagation path is associated with a sensing target;
receiving a sensing measurement report comprising a differential sensing measurement, wherein the differential sensing measurement indicates a difference in measured values associated with the first propagation path and the second propagation path; and
determining sensing information based at least in part on differential sensing measurement.
